(19) United States
(12) Patent Application Publication
(10) Pub. No.: US 2021/0073819 A1
(43) Pub. Date: Mar. 11, 2021

(54) SYSTEMS FOR DETECTING APPLICATION, DATABASE, AND SYSTEM ANOMALIES

(71) Applicant: DefenseStorm, Inc., Alpharetta, GA (US)

(72) Inventors: Alejandro M. Hernandez, Aragon, GA (US); Edgardo Ivan Nazario Perez, Lynnwood, WA (US)

(21) Appl. No.: 17/018,066

(22) Filed: Sep. 11, 2020

Related U.S. Application Data
(60) Provisional application No. 62/898,885, filed on Sep. 11, 2019.

(51) Int. Cl. G06Q 20/40; G06F 16/9035; G06N 20/00; G06K 9/62; G06F 11/07

(52) U.S. Cl. CPC G06Q 20/4016; G06Q 20/4015; G06F 11/0793; G06N 20/00; G06K 9/6256; G06F 16/9035

(57) ABSTRACT

Detecting fraudulent activity can include receiving, via at least one computing device, transactional data from a first computing system, the transactional data comprising data describing at least one transaction and user identifying information. The transactional data can be determined to correspond to a particular user account. Mobile device data associated with the particular user account can be received. Based on a comparison of the transactional data to the mobile device data, a likelihood of a fraudulent event can be determined. In response to the likelihood of the fraudulent event exceeding a predefined threshold, one or more remedial actions can be performed.

### CROSS-REFERENCE TO RELATED APPLICATIONS

This application claims priority to and the benefit of U.S. Application No. 62/898,885, filed Sep. 11, 2019, entitled “SYSTEMS FOR DETECTING APPLICATION, DATABASE, AND SYSTEM ANOMALIES,” which is incorporated herein by reference in its entirety.

### TECHNICAL FIELD

The present disclosure relates generally to systems and methods for detecting anomalous activities, behaviors, and events occurring within and across systems, applications, and databases.

### BACKGROUND

Previous systems and solutions for identifying atypical activities in a customer system may focus solely on detecting externally-based threats, such as, for example, detecting intrusions into a single system. However, customer systems may be compromised by internally-based activities and/or by coordinated activities across multiple systems or having both external and internal elements. For example, a previous system may detect that an external actor has obtained unauthorized access to a customer account at a particular institution. However, in the same example, the previous system may fail to identify an instance where an employee at the particular institution obtained unauthorized access to a customer account and/or to an administrative account. Accordingly, previous systems and solutions may fail to monitor for and/or detect all atypical activity occurring throughout a customer system, especially where atypical activity occurs partially or wholly amongst internal system elements and actors.

Therefore, there is a long-felt but unresolved need for a system or process that detects atypical activities, behaviors, and events occurring across internal, external, and hybridized systems, applications, and databases.

### BRIEF SUMMARY OF THE DISCLOSURE

Briefly described, and according to one embodiment, aspects of the present disclosure generally relate to systems and methods for detecting anomalous activities and events occurring within and between one or more systems, applications, and/or databases.

In one or more embodiments, provided herein is a system for detecting and correlating atypical activities, behaviors, and events occurring across various systems, applications, and databases. For example, embodiments of the present system can monitor and analyze all network activities occurring throughout external systems that include, but are not limited to, wire transfer systems, banking systems, teller systems, online and/or e-banking systems, telephone banking systems, bill payment systems, data warehouses, mobile deposit capture services, account opening services, customer communication services, and internal fraud detection services. The system can formulate baseline definitions and/or parameters of typical activities, behaviors, and events. The system can configure one or more triggers for detecting activities, behaviors, and events that deviate from the typical activity and/or deviate from baseline definitions and/or parameters. The system can detect and report atypical activities, behaviors, and events.

In an exemplary scenario, an embodiment of the present system identifies typical login and activity patterns for an administrator account that is provided particular privileges and access to critical elements of a customer service system. In this example, the system determines that logins for the particular administrator account typically occur twice per day, once during a morning time interval and once during an afternoon time interval. In the same example, the system continuously detects and analyzes the activity of an administrative account to detect deviations from the identified login and activity patterns. The system can detect an atypical pattern of several login attempts occurring throughout disparate time intervals throughout a 24-hour period. The system can further determine that a particular login attempt was followed by initiation of authorization for the opening of a new checking account, the new checking account being associated with a particular account.

Continuing the scenario, the system identifies typical transaction patterns with which the particular account is associated. In this example, the system determines that deposits and transactions from the customer account typically occur via an e-banking system, and also occur biweekly. In the same example, the system detects that a transaction from the newly-created checking account was processed via a teller system, and that the transaction occurred outside of the identified biweekly interval. The system can determine that the transaction amount exceeds historical deposits the other accounts with which the particular account is associated. Based on the various determinations of atypical activity, the system can compute a likelihood of fraud. The system can compare the likelihood of fraud to one or more predetermined thresholds. In response to the likelihood of fraud meeting the predetermined threshold, the system can perform actions including, but limited to, generating and transmitting an alert, identifying a particular teller that processed the transaction via the teller system, suspending and/or halting transactional services to the particular account, and transmitting a notification to a computing device with which the administrator account is associated.

In at least one embodiment, the present system is configured to receive data and information from external systems. Data with which the external system is associated can be referred to as monitoring data and can be received via one or more data feeds. A data feed can include, for example, a particular network connection and/or an application programming interface (API) by which the present system communicates with the external system. For example, the one or more data feeds may include, but are not limited to, administrative audit feeds, bank user activities audit feeds, customer user activities audit feeds, transactional information feeds, and database audit feeds. Embodiments of the present system may retrieve data from a customer system via one or more data access methods including, but not limited to, batch file transfers, log data transfers, stream-based transfers, and virtually real-time application programming interfaces (API's), such as, for example, Open Database Connectivity (ODBC) or Java Database Connectivity (JDBC).

In at least one embodiment, the present system may include a bi-directional data feed that allows the system to provide identified fraudulent and/or anomalous activities, events, patterns, and other information as an input to a fraud system included in a customer system (e.g., thereby potentially allowing for corrective and/or preventative modifications thereto, or potentially improving identification efficacy in future fraud detection processes). For example, embodiments of the present system may include a bi-directional data feed by which the system transmits non-transactional fraud alerts to a fraud system, and receives transactional fraud alerts from the fraud system. In various embodiments, the present system may also collect and/or receive information by receiving and processing inputs from one or more user accounts, computing devices, and third-party systems. For example, data can be received from a customer fraud team that performs fraud detection activities for a particular external system. As another example, data can be received from an external system team comprising subject matter experts in cyber-fraud, cybersecurity, and/or cyber compliance.

In particular embodiments, the present system may include multiple services for detecting fraudulent and/or anomalous activities. For example, exemplary services of the present system may include, but are not limited to, an electronic delivery systems (EDS) monitoring service, an application database (AD) monitoring service, a core/ancillary systems (CAS) monitoring service, a general ledger/accounts (GLA) monitoring service, and an alert service. The system can include one or more tools (e.g., a particular set of computing resources) for supporting various fraud monitoring and detection processes. For example, the system can include a threat tool, a pattern tool, a compliance tool, and a trigger tool among other tools. The threat tool can provide data associated with known fraudulent actors of activities. The pattern tool can analyze monitoring data to identify various patterns, such as, for example, atypical transactional activities or account behavior that is substantially similar to account behaviors with which historical fraud events are associated. The compliance tool can provide various compliance rules, policies, and criteria and can analyze monitoring data to determine if compliance policies are adhered to.

The trigger tool can enforce various thresholds and triggers for evaluating monitoring data and outputs of monitoring data analysis processes. While previous approaches may include trigger-able conditions and/or thresholds, embodiments of the present system may provide an advantageously more thorough and more holistic assessment of a customer system's activities, because the system can integrate and correlate data from a variety of connected and independent systems. For example, a previous solution may include a trigger for detecting anomalous logins to a core banking system included in a customer system; however, the previous solution would fail to detect anomalous logins occurring in e-banking systems, teller systems, phone banking systems, and other systems included in the customer system. In contrast, because embodiments of the present system can receive and analyze activity from each and every system included in a customer system, the system may identify anomalous logins occurring in the e-banking systems, teller systems, phone banking systems, and the other systems.

In at least one embodiment, the present system may include one or more portals that provide real-time and historical summaries of system activities, settings, and configurations. A portal can include a particular networking destination at which one or more user interfaces and various data are served. The portal can allow a user of the system to communicate with a contributor of the system (e.g., to discuss and resolve potentially fraudulent activities detected by the present system). The portal can be configured to receive inputs for configuring one or more elements of system operations (e.g., for example, trigger settings, alert settings, etc.).

In various embodiments, the present system may integrate and analyze outputs of one or more services to provide, for example, fraud detection, cyber-risk, cyber compliance, and/or other security analyses and solutions. For example, embodiments of the present system may integrate and analyze login data across multiple external systems and services to identify logins originating from foreign countries and/or from predefined and/or dynamically defined high-risk countries. In comparison, previous solutions may only analyze login data for a single customer system service, and, thus, may fail to identify atypical login activities occurring in other elements of the customer system.

Embodiments of the present system can cause one or more actions to be initiated at the system or at one or more external systems. The actions can be remedial actions that are triggered in response to detecting fraudulent and/or anomalous activities. Non-limiting examples of remedial actions include, but are not limited to, generating and transmitting alerts (e.g., to a system user or system contributor, such as, for example, a fraud department of a customer system), contacting law enforcement and/or regulatory entities, and suspending and/or blocking access to a customer system for a particular user, IP address, location, etc.

Previous approaches to identifying atypical system activity and detecting potentially adverse activities may include individually analyzing systems and services. However, adverse activities (e.g., fraud and other behaviors threatening cybersecurity and/or cyber compliance) may only be detectable via integrated analyses of multiple interconnected and/or disparate systems, services, and data sources. Accordingly, embodiments of the present system (as described herein) may provide a novel approach for integrating and correlating information, data, and policies from multiple systems and services such that fraud detection and other cybersecurity processes may detect a spectrum of fraud types and cybersecurity risks that may otherwise be undetectable via previous solutions. For example, embodiments of the present system may provide a novel approach for correlating an institution's employee activities on an internal network to activities occurring across the institution's various banking systems, thereby correlating the institution's employee activities to transactional activities across all internal and external platforms. In the same example, the present system may provide a single, integrated console to alert an institution of potentially fraudulent or anomalous activities, and to investigate and document the same.

In one or more embodiments, the present system may incorporate one or more traditional elements, such as those described in U.S. patent application Ser. No. 16/075,563, entitled “ENTERPRISE POLICY TRACKING WITH SECURITY INCIDENT INTEGRATION,” which is incorporated herein by reference, as if set forth in its entirety. However, the present system may include advancements over traditional elements including, but not limited to, identifying typical and atypical activity patterns within and across systems, applications, and databases, and integrating and correlating activity across multiple systems, applications, and databases to identify anomalous and/or atypical activities that may otherwise appear typical (e.g., when evaluated in isolation, with respect to a single system, application, or database). For example, previous systems, in identifying anomalous activities, may only consider whether or not a login attempt included correct credentials. In contrast, an embodiment of the present system may, in addition to verifying credentials, analyze historical login events to identify typical login patterns, and may utilized identified typical login patterns to detect login activity deviating therefrom.

According to a first aspect, a method comprising: A) receiving, via at least one computing device, transactional data from a first computing system, the transactional data comprising data describing at least one transaction and user identifying information; B) determining, via the at least one computing device, that the transactional data corresponds to a particular user account; C) receiving, via the at least one computing device, mobile device data associated with the particular user account; D) determining, via the at least one computing device, a likelihood of a fraudulent event based on a comparison of the transactional data to the mobile device data; and E) in response to the likelihood of the fraudulent event exceeding a predefined threshold, performing, via the at least one computing device, a remedial action.

According to a further aspect, the method of the first aspect or any other aspect, wherein the transactional data comprises a first geographic position associated with the at least one transaction and the mobile device data comprises a second geographic position associated with a mobile device.

According to a further aspect, the method of the first aspect or any other aspect, wherein determining the likelihood of the fraudulent event comprises: determining a distance between the first geographic position and the second geographic position, wherein the likelihood of the fraudulent event is based at least in part on the distance.

According to a further aspect, the method of the first aspect or any other aspect, wherein determining the likelihood of the fraudulent event comprises: determining a difference between a first time that the at least one transaction occurred and a second time that the mobile device data was captured, wherein the likelihood of the fraudulent event is based at least in part on the difference between the first time and the second time.

According to a further aspect, the method of the first aspect or any other aspect, further comprising comparing the user identifying information and the mobile device data to a customer service log associated with the particular user account.

According to a further aspect, the method of the first aspect or any other aspect, further comprising determining a likelihood of fraudulent activity based at least in part on the comparison between the customer service log, the user identifying information, and the mobile device data.

According to a further aspect, the method of the first aspect or any other aspect, wherein determining the likelihood of the fraudulent event comprises executing a machine learning model on the transactional data and the mobile device data.

According to a further aspect, the method of the first aspect or any other aspect, wherein the machine learning model is trained to differentiate between non-fraudulent and fraudulent activity using a training dataset, wherein the training dataset comprises: A) a first subset comprising historical transactional data that is not associated with fraudulent activity; and B) a second subset that excludes the first subset and comprises the historical transactional data that is associated with fraudulent activity.

According to a second aspect, a system comprising: A) a data store; and B) at least one computing device in communication with the data store, the at least one computing device being configured to: 1) receive transactional data from a first computing system, the transactional data comprising data describing at least one request and user identifying information; 2) determine that the transactional data corresponds to a particular user account; 3) receive mobile device data associated with the particular user account; 4) determine a likelihood of a fraudulent event based on a comparison of the transactional data to the mobile device data; and 5) in response to the likelihood of the fraudulent event exceeding a predefined threshold, perform a remedial action.

According to a further aspect, the system of the second aspect or any other aspect, wherein; A) the request comprises a service provider identifier associated with a computing device from which the request was received; and B) the mobile device data comprises a second service provider identifier associated with a second computing device from which the mobile device data originated.

According to a further aspect, the system of the second aspect or any other aspect, wherein the at least one computing device is further configured to determine that the service provider identifier does not match the second service provider identifier, wherein the likelihood of the fraudulent event is based at least in part on the determination.

According to a further aspect, the system of the second aspect or any other aspect, wherein the remedial action comprises enforcing a dual-authentication setting for the particular user account.

According to a further aspect, the system of the second aspect or any other aspect, wherein the at least one computing device is further configured to compare the user identifying information and the mobile device data to an administrator access log associated with the first computing system.

According to a further aspect, the system of the second aspect or any other aspect, wherein the at least one computing device is further configured to determine a likelihood of fraudulent activity based at least in part on the comparison of at least two of: the administrator access log, the transactional data, and the mobile device data.

According to a third aspect, a non-transitory computer-readable medium embodying a program that, when executed by at least one computing device, causes the at least one computing device to: A) receive service data from a first computing system, the service data comprising a service log and user identifying information; B) determine that the service data corresponds to a particular user account; C) receive mobile device data associated with the particular user account; D) determine a likelihood of a fraudulent event based on a comparison of the service data to the mobile device data; and E) in response to the likelihood of the fraudulent event exceeding a predefined threshold, perform a remedial action.

According to a further aspect, the non-transitory computer-readable medium of the third aspect or any other aspect, wherein: A) the service log comprises a credential reset request associated with a first time; and B) the mobile device data comprises an application access log associated with a second time.

According to a further aspect, the non-transitory computer-readable medium of the third aspect or any other aspect, wherein the program further causes the at least one computing device to determine a difference between the first time and the second time, wherein the likelihood of the fraudulent event is based at least in part on the difference.

According to a further aspect, the non-transitory computer-readable medium of the third aspect or any other aspect, wherein the program further causes the at least one computing device to receive second service data from a second computing system, the second service data comprising an automated teller machine request associated with a third time.

According to a further aspect, the non-transitory computer-readable medium of the third aspect or any other aspect, wherein determining the likelihood of the fraud event further comprises: A) determining a difference between the first time and the third time; and B) comparing the automated teller machine request to the credential reset request, wherein the likelihood of the fraudulent event is based at least in part on the determination, the difference, and the comparison between the automated teller machine request and the credential reset request.

According to a further aspect, the non-transitory computer-readable medium of the third aspect or any other aspect, wherein the program further causes the at least one computing device to transmit an alert to a second computing system associated with the particular user account.

These and other aspects, features, and benefits of the claimed systems and methods will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 shows an exemplary networked environment according to one embodiment of the present disclosure;

FIG. 2A shows an exemplary monitoring system according to one embodiment of the present disclosure;

FIG. 2B shows an exemplary monitoring system according to one embodiment of the present disclosure;

FIG. 2C shows an exemplary monitoring system according to one embodiment of the present disclosure;

FIG. 3 shows an exemplary monitoring process according to one embodiment of the present disclosure;

FIG. 4 shows an exemplary data analysis process according to one embodiment of the present disclosure;

FIGS. 5A-B show exemplary cyber-fraud portals according to one embodiment of the present disclosure;

FIG. 6 shows an exemplary electronic delivery systems (EDS) portal according to one embodiment of the present disclosure;

FIG. 7 shows an exemplary application database portal according to one embodiment of the present disclosure;

FIG. 8 shows an exemplary core/ancillary systems portal according to one embodiment of the present disclosure;

FIGS. 9A-C show exemplary alert portals according to one embodiment of the present disclosure; and

FIGS. 10A-D show exemplary ticket portals according to one embodiment of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

As used herein, a fraud event generally refers to illegal or policy-violating activity occurring across one or more systems, such as, for example, one or more banking- and transaction-related systems.

### Overview

Aspects of the present disclosure generally relate to detecting fraudulent activities occurring at or across one or more external systems. In at least one embodiment, the present system may provide monitoring and analytical services for identifying specific internal and external activities that may deviate from typical and/or permitted activity.

For example, embodiments of the present system may monitor and analyze all network activities occurring across a customer system, including all internal and external systems, platforms, applications, databases, and services. In various embodiments, the present system may also integrate and correlate information and data streams from disparate sources to identify atypical activities that may be undetectable via analysis of a single source. For example, embodiments of the present system may collect and/or receive data from a multitude of sources and analyze collected data to determine if recent customer system activities deviate from typical, historical activities. In at least one embodiment, by identifying typical activity in external systems and detecting deviations therefrom, the present system may recognize internal, external, and hybridized anomalous activities.

The anomalous activities can be related to attempted, on-going, or successful fraudulent and/or security policy-violating actions including, but not limited to, identity fraud, electronic wire fraud, unauthorized remittance and payment adjustments, and illegal or prohibited user account activity.

### Exemplary Embodiments

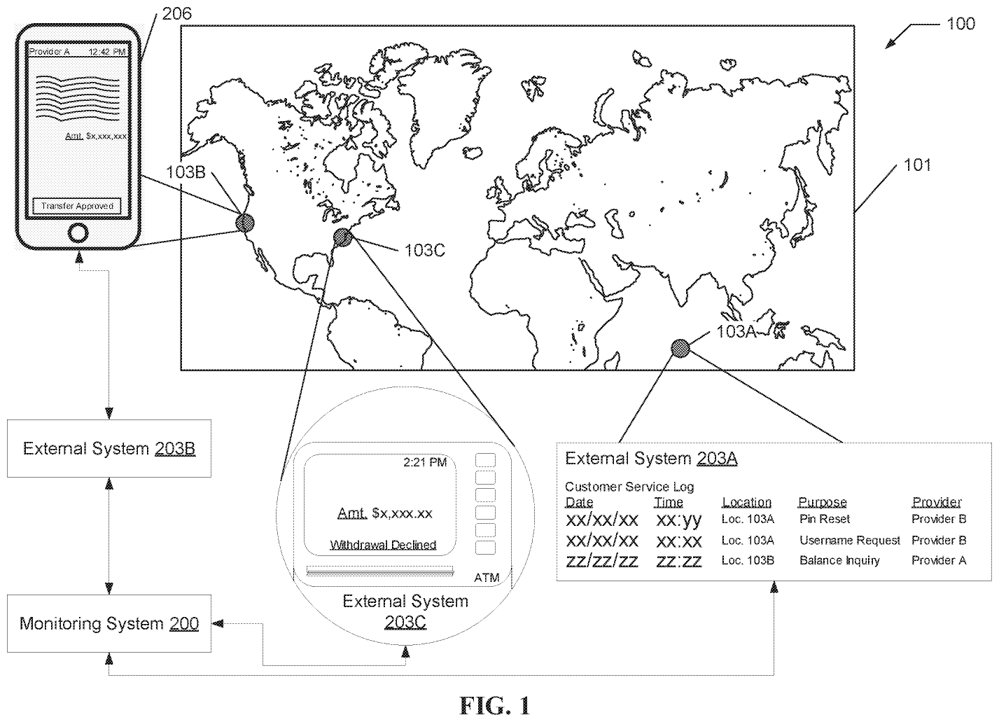

Referring now to the figures, for the purposes of example and explanation of the fundamental processes and components of the disclosed systems and processes, reference is made to FIG. 1, which illustrates an exemplary networked environment 100. As will be understood and appreciated, the exemplary, networking environment 100 shown in FIG. 1 represents merely one approach or embodiment of the present system, and other aspects are used according to various embodiments of the present system.

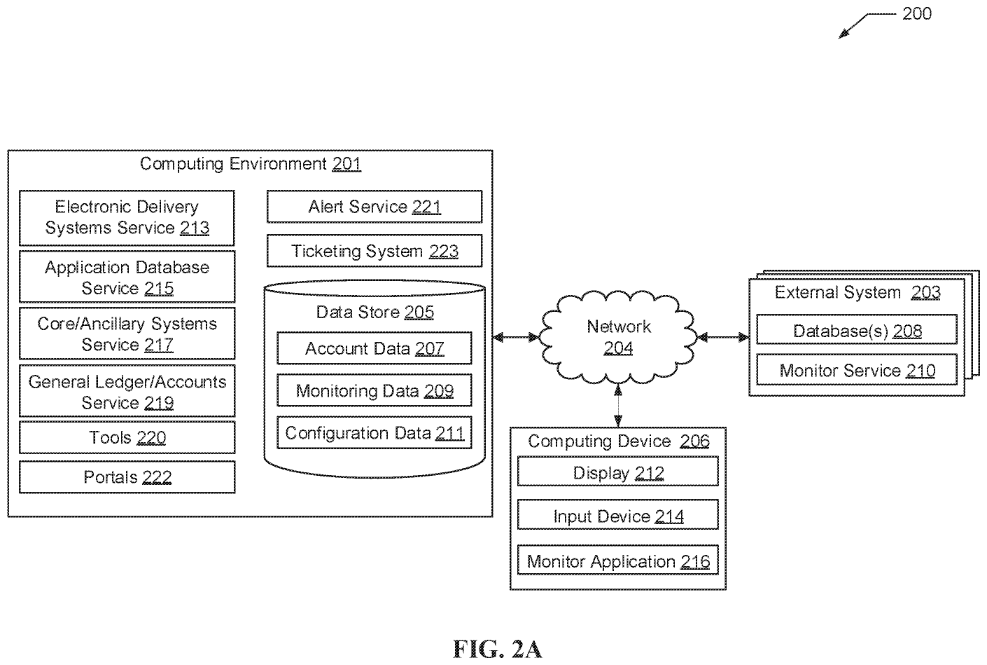

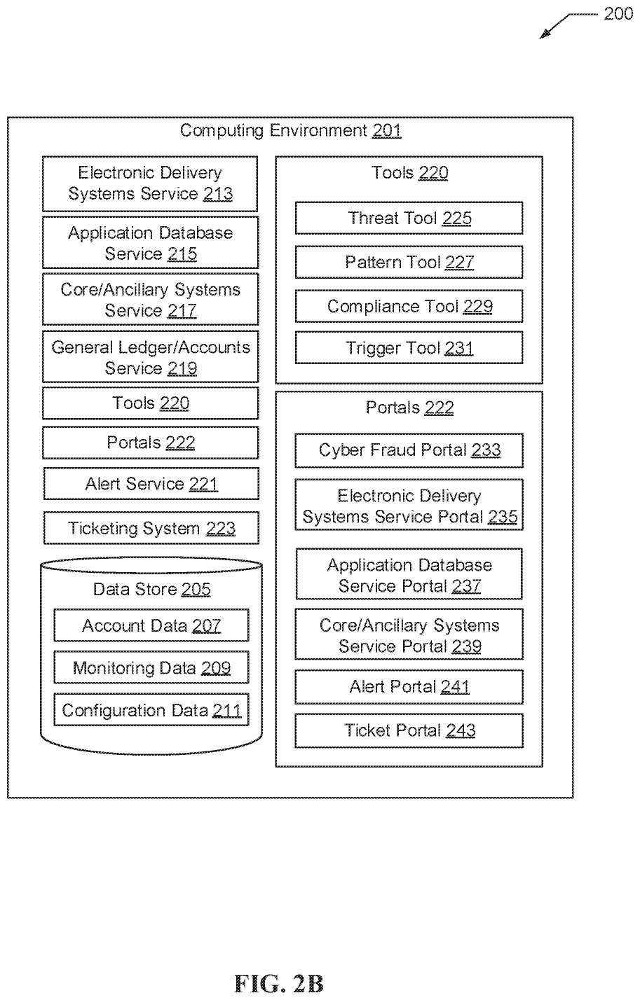

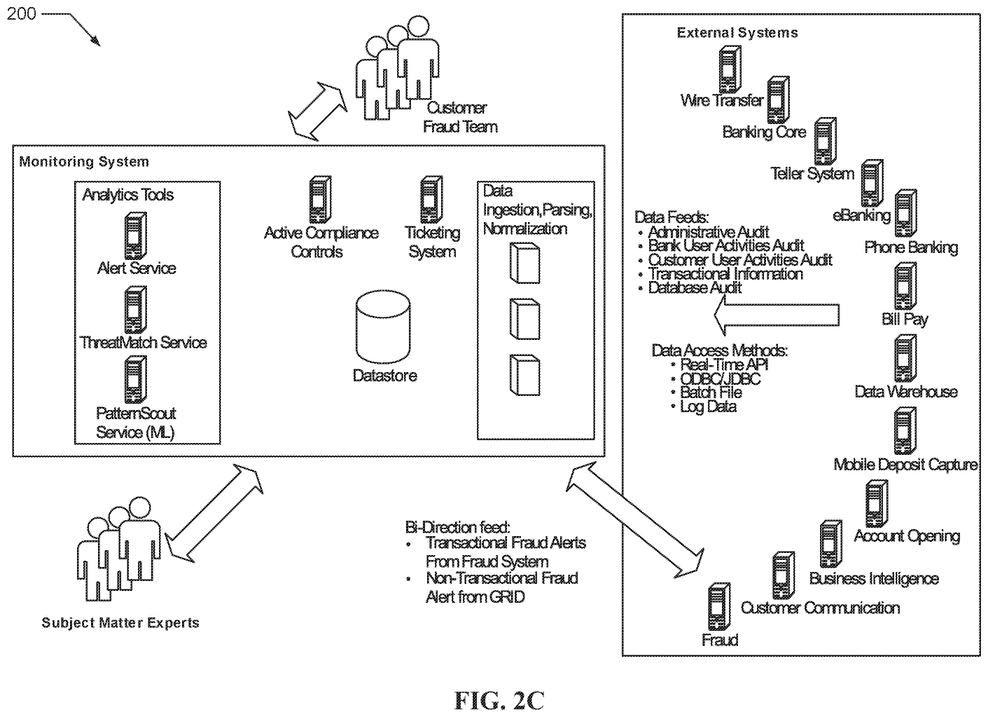

With reference to FIG. 1, shown is an exemplary networked environment 100. For the purposes of illustration and description, FIG. 1 includes an interface 101 on which a map is rendered. The interface 101, for example, can include a user interface accessible via one or more portals 222 (not shown, see FIG. 2). The networked environment 100 can include a monitoring system 200 in communication with external systems 203A-C. The external system 203A can include a customer service system. The external system 203B can include a mobile banking system that is accessible to a computing device 206. The computing device 206 can include, for example, a smartphone and can be associated with a particular user account. The external system 203C can include an automatic teller system comprising an automatic teller machine (ATM).

The monitoring system 200 can be configured to monitor and analyze activities occurring throughout the external system 203A-C. Based on outputs of various analytical processes, the monitoring system 200 can identify particular activities or activity patterns that may deviate from typical and/or permitted activities, or may otherwise be associated with potentially fraudulent behavior. The monitoring system 200 can integrate and correlate data from each of the external systems 203A-C to identify atypical activities that may be undetectable via analysis of a single source. For example, the monitoring system 200 can receive and analyze monitoring data comprising various requests received at external systems and can determine that one or more of the requests are potentially fraudulent.

For the purposes of illustration and description, the following section provides an exemplary scenario of fraud monitoring and detection. In an exemplary scenario, the monitoring system 200 receives monitoring data from the external systems 203A-C. The monitoring system 200 aggregates the monitoring data (e.g., by creating a combined time-series record of activities occurring at the external systems).

At a first time interval and from a location 103A, the external system 203B (e.g., a customer service system) can receive a first and a second request, the first and second request being associated with a service provider A and a particular account. The first request can include a username request and the second request includes a pin change request. At a second time interval and from a second location 103B, the external system 203B (e.g., a mobile banking application) can receive a request from a computing device 206 to initiate a balance transfer. At a third time interval and from a third location 103C, the external system 203C (e.g., an ATM system) can receive a fourth request, the third request including a withdrawal action request for a particular amount.

The monitoring system 200 can aggregate and analyze the various requests and generates various determination. For the purposes of description, the various determinations are described sequentially; however, it will be understood and appreciated that the various determinations can occur substantially concurrently. To generate a first determination, the monitoring system 200 can compute a distance and estimated travel time between each of the locations 103A-B. The monitoring system 200 can compute a duration between the times at which each of the requests were received. The monitoring system 200 can compare each estimated travel time to each duration. Based on the comparisons, the monitoring system 200 can determine that it would have been physically impossible for a user to initiate the first and second requests to the customer service system at location 103A and to then travel to the location 103B and initiate the request to the mobile banking system.

To generate a second determination, the monitoring system 200 can retrieve a request location history with which the particular account is associated. The monitoring system 200 can compare the request location history to the locations 103A-C. Based on the comparison, the monitoring system 200 can determine that previous requests have been received at the location 103B but no previous requests have been received at the locations 103A or 103C. To generate a third determination, the monitoring system 200 can retrieve historical customer service logs with which the particular account is associated. The monitoring system 200 can compare the customer service logs to the first and second requests. Based on the comparison, the monitoring system 200 can determine that, whereas the first and second requests are associated with the Provider B, previously received requests are associated with a Provider A.

The monitoring system 200 can provide the monitoring data and the first, second, and third determinations to a trained machine learning model for predicting fraud likelihood. The machine learning model can generate an output comprising a fraud likelihood score and the monitoring system 200 can compare the fraud likelihood score to one or more thresholds. The thresholds can be generated by the trained machine learning model (or another model) based on historic monitoring data (e.g., comprising various levels of known fraudulent activity). Based on the comparison, the monitoring system 200 can determine that a fraud event has occurred and cause one or more remedial actions to occur. The one or more remedial actions include preventing approval of the ATM request at the location 103C, transmitting a fraud alert to the external systems 203A-C, forcing a credential update for the particular account, and configuring one or more of the external systems 203A-C to require dual-authentication processes for the particular account.

With reference to FIG. 2A, shown is an exemplary monitoring system 200. The monitoring system 200 can include a computing environment 201 in communication with a plurality of external systems 203 and one or more computing devices 206 over a network 212. The elements of the computing environment 201 can be provided via a plurality of computing devices that may be arranged, for example, in one or more server banks or computer banks or other arrangements. Such computing devices can be located in a single installation or may be distributed among many different geographical locations. For example, the computing environment 201 can include a plurality of computing devices that together may include a hosted computing resource, a grid computing resource, and/or any other distributed computing arrangement. In some cases, the computing environment 201 can correspond to an elastic computing resource where the allotted capacity of processing, network, storage, or other computing-related resources may vary over time. The network 212 includes, for example, the Internet, intranets, extranets, wide area networks (WANs), local area networks (LANs), wired networks, wireless networks, or other suitable networks, etc., or any combination of two or more such networks. For example, such networks can include satellite networks, cable networks, Ethernet networks, and other types of networks.

An external system 203 can include one or more systems associated with an entity, such as a financial institution. Non-limiting examples of external systems 203 include, but are not limited to, wire transfer systems, banking systems, such as, for example, banking cores, teller systems, such as, for example, systems for configuring customer accounts, and for processing deposits and withdrawals to and from customer accounts, online and/or e-banking systems, such as, for example, mobile banking software in communication with mobile applications running on a mobile electronic device, telephone banking systems, bill payment systems, data warehouses such as, for example, distributed, cloud-based data warehouses, mobile deposit capture services, such as, for example, mobile capture check depositing applications, account opening services, customer communication services, such as, for example, an online customer service platform, and internal fraud detection services, such as, for example, a customer fraud detection system. Other examples of external systems 203 include, but are not limited to, business intelligence sources, such as, for example, a data mining and analytics service. The external system 203 can include one or more databases 208 that can be accessible to the computing environment 201. The database 208 can store, for example, historical monitoring data, user account data, policies, and configurations. The external system 203 can include a monitor service 210, such as, for example, a native fraud detection service configured for analyzing activities occurring within the external system 203.

The computing device 206 can be any network-capable device including, but not limited to, smartphones, computers, tablets, smart accessories, such as a smartwatch, key fobs, and other external devices. The computing device 206 can include a processor and memory. The computing device 206 can include a display 212 on which various user interfaces can be rendered. The computing device 206 can include an input device 214 for providing inputs, such as requests and commands, to the mobile device 206. The input device 214 can include a keyboard, mouse, pointer, touch screen, speaker for voice commands, camera or light sensing device to reach motions or gestures, or another input device. The computing device 206 can include a monitor application 216 configured to process inputs and transmit commands, requests, or responses to the computing environment 201 and one or more external systems 203.

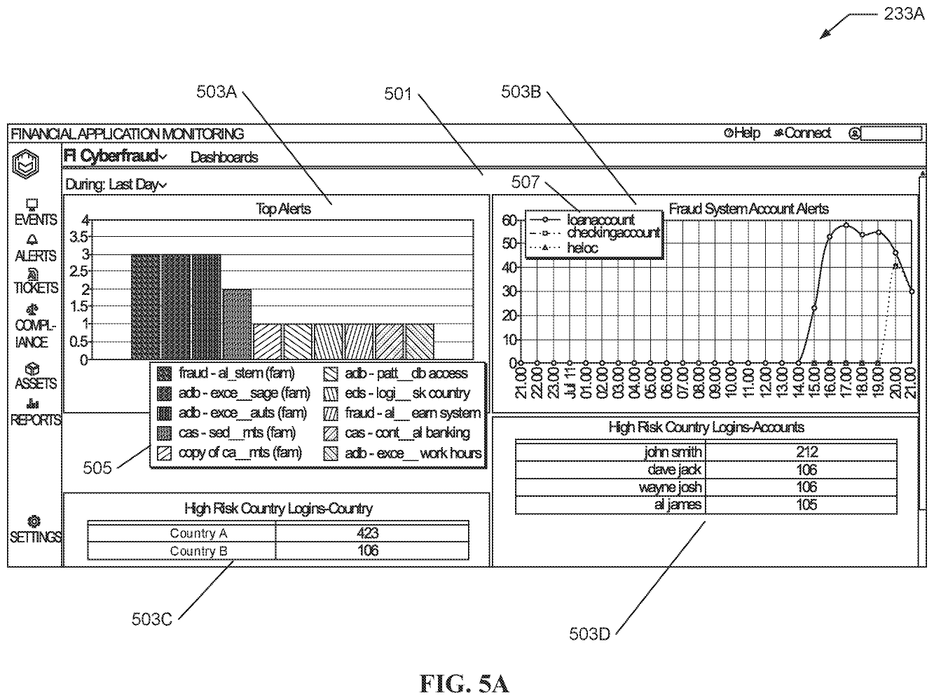

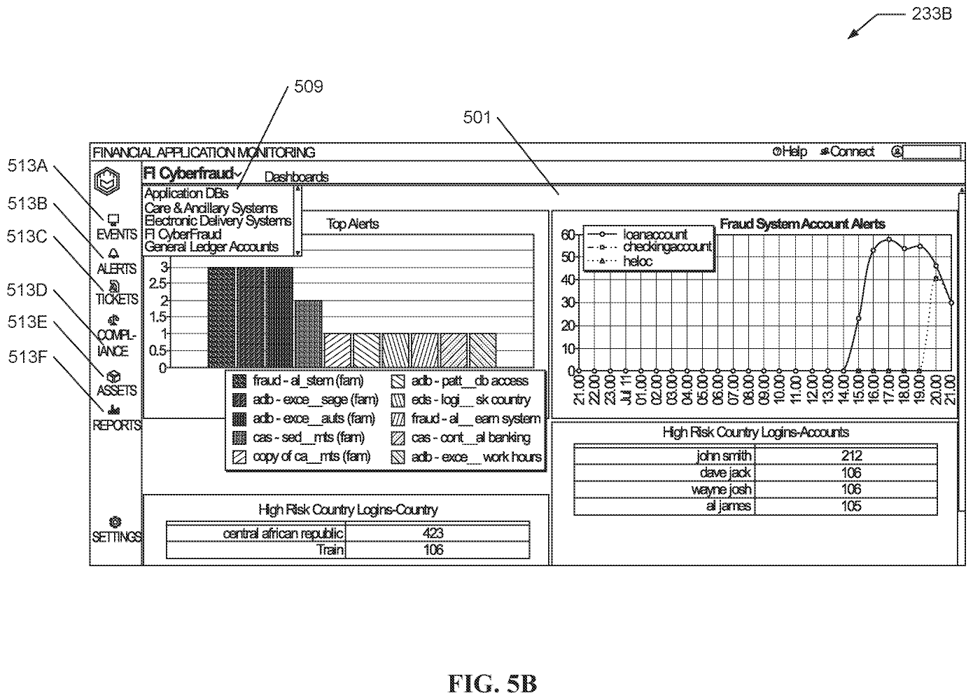

The computing environment 201 can include a data store 205 and one or more services configured for performing various monitoring and analytical processes. The data store 205 can store various data that is used by the various elements of the computing environment 201 to execute various processes and functions discussed herein. The data store 205 can be representative of a plurality of data stores 112 as can be appreciated. The data store 205 can include, but is not limited to account data 207, monitoring data 209, and configuration data 211. The account data 207 can include data associated with one or more user accounts. For example, the account data 207 includes credentials (e.g., usernames, passwords, public-private key pairs, etc.) for authenticating interactions of users with the computing environment 201. In another example, the account data 207 includes credentials for authenticating communications between the computing environment 201 and one or more external systems 203. The account data 207 can include various preferences for controlling an appearance and arrangement of user interfaces (e.g., such as the exemplary user interfaces shown in FIGS. 5A-10D).

The monitoring data 209 can include data from various external systems 203, as well as outputs from various processes applied to the data (e.g., such as normalization and analytical processes). In one example, monitoring data 209 comprises transactional and location data (e.g., comprising one or more geographic positions) associated with a particular user account. Transactional data can include, for example, user identifiers, banking information, such as transaction amounts, timestamps, credentials, and networking information, such as IP addresses and configuration data. The transactional data can include information associated with a computing device 206 with which transactional activity is associated, such as, for example, MAC address, phone number, phone provider, device type, and other data. The location data can include, for example, global positioning system (GPS) data or other identifiers determining a particular geographic position. The location data can include data associated with a source and a destination corresponding to a particular transaction. In one example, for a particular transaction, location data includes positional data associated with a computing device 206 from which a transaction was initiated and positional data associated with a particular external system and/or a second computing device 206 at which the transaction was processed or resolved.

The monitoring data 209 can include, but is not limited to, database activity monitoring data, administrative activity monitoring data, employee activity monitoring data, and customer activity monitoring data. Database activity monitoring data may include, for example, transaction logs, user ids, activities, activity data, and time information. In at least one embodiment, database activity monitoring data may be sourced from any database user (e.g., service account or actual user). Administrative activity monitoring data may include, for example, application-specific activity logs (e.g., from all banking systems) including, but not limited to, administrative logins, user access and/or role changes, and system configuration changes. In one example, administrative activity monitoring data includes IP addresses, timestamps, and action logs (e.g., for example, requests for fund transfers, waivers of fees, rate adjustments, etc.). Employee activity monitoring data may include, for example, user logs and user activities. Exemplary user activities can include, but are not limited to, looking up an account balance, creating a new account for a customer, and updating a customer's information. Customer activity monitoring data may include, for example, activity logs from all elements of a customer system with which a customer interacts. The activity logs may include, but are not limited to, interactions with e-banking systems, ATMs, and phone banking systems. Activity logs may include, but are not limited to, user logins, looking up an account balance, and/or updating information (e.g., such as a phone number).

The configuration data 211 can include configuration parameters, properties, and settings for controlling various activities and processes of the computing environment 201. The configuration data 211 can include triggers and thresholds for assessing outputs of various monitoring process. For example, the configuration data 211 can include a trigger for monitoring login activities across a plurality of external systems 203. In this example, the trigger can include an expected location (e.g., based on a historical pattern of login activities), time, and IP address with which logins for a particular user account are associated. In the same example, the trigger is used to determine if monitoring data 209 comprising a new location, time, and IP address corresponds to a potential fraud event.

The computing environment 201 can include one or more services for performing various functions and processes. For example, the computing environment can include, but is not limited to, an electronic delivery systems (EDS) service 213, an application database service 215, a core/ancillary systems (CAS) service 217, and a general ledger/accounts (GLA) service 219. The separation of services as discussed herein is an exemplary embodiment. Various embodiments are contemplated in which one or more functions of the described services are performed by a single service or an alternative combination of services.

The computing environment 201 can include an electronic delivery system (EDS) service 213. The EDS service 213 can perform various processes including, but not limited to, analyzing and correlating data from external systems 203, such as e-banking systems, online account open and fund systems, telephone banking systems, automated teller machine (ATM) banking systems, teller banking systems, and other systems, services, and platforms with which the financial institution's customers, employees, and affiliates interact. The EDS service 213 can analyze and identify potentially fraudulent activities and unusual usage patterns. For example, the EDS service 213 analyze monitoring data 209, including e-banking activities initiated in foreign countries and/or via web proxy services, to identify unusual usage patterns and/or attempted or successful fraudulent actions. As another example, the EDS service 213 analyzes monitoring data 209 to determine anomalous usage patterns in customer interactions with various banking systems and services. In the same example, the EDS service 213 determines that a customer typically conducts his or her banking via a mobile application-based e-banking system, and the customer typically presents an IP address located in a northwest region of the US. Continuing the example, the EDS service 213 determines that a teller banking system located in the southeastern US attempted to disperse funds from the customer's checking account. Upon identifying the correlation between the customer's typical banking method and location, the EDS service 213 initiates a flag command causing the recorded teller banking activities to be tagged as potentially fraudulent and generating an alert.

The computing environment 201 can include an application database service 215. The application database service 215 can detect and analyze changes to and interactions with external databases 208. The application database service 215 can monitor for unusual access and/or usage of data and data structures (e.g., tables, etc.), and for anomalous administrative access attempts, administrative changes, and other administrator activities (e.g., as pertaining to a financial institution's databases and related applications). The application database service 215 can audit all administrative activities across external databases 208 and related applications and, based on outputs of auditing processes, generate alerts and perform other appropriate actions. For example, the application database service 215 can flag databases, users, and/or application activities that are determined to be outside of expected usage, potentially fraudulent, and/or in violation of one or more policies.

The computing environment 201 can include a core/ancillary system (CAS) service 217. The CAS service 217 can be detect and analyze configuration changes, access privileges, and other activity associated with core and ancillary systems of external systems 203. Core and ancillary systems can include, for example, data warehousing systems and e-banking systems. In one example, the CAS service 217 detects and analyzes login activities and changes to account configurations, such as changes to an ATM limit, a fee rate, or billing dates. The CAS service 217 can generate alerts, for example, in response to detecting potential fraudulent behavior. The CAS service 217 can generate summaries that provide an auditing framework for reviewing potentially fraudulent and/or anomalous activities.

The computing environment 201 can include a general ledger/account (GLA) service 219. The GLA service 219 can monitor activities and access attempts for a general ledger and one or more accounts (e.g., that may be included in a general ledger). The GLA service 219 can analyze activity for end-of-year accounts (or other accounts) and determine an activity level, such as, for example, a low or high transaction activity level. The GLA service 219 can monitor one or more accounts (e.g., account used for end-of-quarter transactions, etc.) to determine changes occurring outside of expected ranges, or occurring outside of specified times. The expected ranges can be determined training a machine learning system by processing historical data from the data store 205. The GLA service 219 can cause an alert service 221 to generate and transmit an alert to one or more associated system users, system contributors, and/or services of an associated external system 203.

The computing environment 201 can include one or more tools 220 that can perform various actions for carrying out processes of the monitoring system 200. The tools 220 can include, for example, a particular set of computing resources and/or a particular program. The tools 220 can perform processes, such as, for example, pattern recognition analyses, threat analyses (e.g., based on a repository of known threats and historical attacks), and policy compliance analyses.

The computing environment 201 can include an alert service 221 configured to generate and transmit alerts (e.g., to an external system 203, computing device 206, or other networked device). An alert can include, but is not limited to, an electronic notification, push alert, email, text message, telephone call, and other electronic messages. An alert can include a summary of a potential fraud event and various input and output data associated with processes by which the potential fraud event was determined. An alert can include a system or user identifier that is associated with a particular system contributor, system user, and/or external system 203. An alert can include one or more potential response options for addressing the potentially fraudulent event, such as locking a user account, contacting authorities, and etc. The system can perform a selected one of the potential responses, such as, for example, in response to a reply text from a mobile device, a number entry from a telephone call, or some other response.

As one example, the alert service 221 may generate and transmit alerts to a particular user of an external system 203 based on a determination of potentially fraudulent activity. In this example, the potentially fraudulent activity includes anomalous events and patterns occurring in an e-banking system, a mobile deposit capture system, and a customer communication system. In the same example, the alert includes a summary of the anomalous events and patterns, such as a time-series log of activities occurring at the e-banking system, mobile deposit capture system, and customer communication system.

The computing environment 201 can include one or more portals 222 by which various data can be accessed and displayed. A portal 222 can include, for example, a web-page or other digital environment accessible at a particular networking address. Various user interfaces can be rendered via the portal 222 and the user interfaces can provide visual summaries of fraud monitoring processes and configurations. The portal 222 can be configured to receive inputs, such as requests and commands, for controlling fraud monitoring processes and other aspects of the system 200.

The computing environment 201 can include a ticketing system 223 configured to receive tickets. A ticket can include an electronic message or alert describing potentially fraudulent and/or anomalous activities (e.g., in one or more external systems 203 and/or for a particular user account). The ticketing system 223 can receive tickets from various sources including, but not limited to, an external system 203, a system user (e.g., via a system profile or user account), and a system contributor, such as, for example, an in-house customer system fraud team. The ticketing system may receive and respond to tickets automatically and/or manually (e.g., via inputs received from a system contributor, such as, for example, a system fraud expert).

With reference to FIG. 2B, shown is a computing environment 201 of a monitoring system 200. For the purposes of description, various elements of the monitoring system 200 of FIG. 2A are omitted in FIG. 2B. Unless indicated otherwise, elements with similar numerals generally include the same or similar functionality. The tools 220 can include, but are not limited to, a threat tool 225, a pattern tool 227, a compliance tool 229, and a trigger tool 231. The separation of tools 220 as discussed herein is an exemplary embodiment. Various embodiments are contemplated in which one or more functions of the described tools are performed by a single tool or a combination of tools. The threat tool 225 can provide information associated with various types of fraud and other illicit activities to which an external system may be vulnerable. The threat tool 225 can receive and processes historical fraud data, patterns, trends, reports, and other information. For example, the threat tool 225 can receive data from various anti-fraud institutions and/or agencies comprising known patterns of fraudulent behaviors and other data for identifying fraudulent actors. In this example, the threat tool 225 can improve fraud monitoring processes by providing means for the monitoring system 200 to compare monitored activities to known fraudulent, or otherwise security policy-violating, activities. In another example, the threat tool 225 can receive blacklists comprising IP addresses, locations, and/or other data with which historical fraud events are associated.

The pattern tool 227 can analyze historical data to determine baseline patterns and trends of activities occurring at one or more external systems 203. The pattern tool 227 can analyze data, such as monitoring data 209, to determine deviations from identified patterns and trends. The pattern tool 227 can be configured to perform analyses based at least in part on one or more pattern triggers that are each associated with a particular anomalous event or activity. The pattern tool 227 can automatically and substantially continuously monitor an external system 203 for the particular anomalous event or activity, and, upon detecting, the event or activity. For the purposes of this disclosure, automatically can refer to a computer performing functionality without human interaction required to initiate the action. The pattern tool 227 can cause the alert service 221 to generate and transmit an alert in response to determining the presence of anomalous and/or potentially fraudulent activity.

The pattern tool 227 can perform one or more machine learning techniques to model current and historic anomalous activities or events, and generate models for predicting or identifying fraudulent behavior in future activities or events. The pattern tool 227 can perform one or more machine learning techniques to identify triggers and/or alerts most frequently associated with confirmed fraud, thereby better informing future trigger configuration, monitoring and alert operations. The pattern tool 227 can compute various metrics for comparing historical data and data associated with potentially fraudulent activities. The various metrics can be used in the described fraud monitoring and data analysis processes to predict a likelihood of a fraud event. For example, the various metrics can be used to generate parameters and input data for a machine learning model that outputs a score for predicting likelihood of fraud.

In some embodiments, the pattern tool 227 can determine statistical metrics on a data set. As an example, the pattern tool 227 can determine an average and median value or frequency of ATM withdrawals by a particular user, in a particular region, or in general. The pattern tool 227 can calculate standard deviations around the value to identify outliers that meet or exceed preconfigured standard deviations. As an example, the pattern tool 227 can determine that a 98% confidence window of an amount of a teller-based withdrawal for a particular user is between $0 and $500, such that an attempted withdrawal of over $500 can trigger a remedial action or contribute to an overall decision to trigger a remedial action when combined with similar potential fraud indicators from other analysis. As another example, the pattern tool 227 can determine that a 95% confidence window of an amount of travel that a duration of travel that a particular user will undertake in a year to be between zero and fifteen days. If the particular user has purchases outside of a geofence around the home address of the particular user for more than fifteen days, the system can trigger a remedial action or contribute to an overall decision to trigger a remedial action when combined with similar potential fraud indicators from other analysis.

The pattern tool 227, among other tools described herein, can combine configurable thresholds with machine learning to detect potentially fraudulent activities an administratively definable sensitivity. As an example, an administrator can configure various parameters associated with a likelihood of a false-positive identification of fraud and a likelihood of a positive identification of fraud. The system can generate parameters using machine learning analysis of historical data to achieve the configured false-positive and/or positive identification rates.

The compliance tool 229 can receive, process, and configure cyber compliance policies, monitor an institution for violations thereof, and generate displays, such as user interfaces, comprising cyber compliance activities (e.g., for example, recently detected cyber compliance violations, anomalous activities, etc.). For example, the compliance tool 229 is configured to monitor an institution's external system 203 for violations of governmental cyber compliance policies and security standards (e.g., FFIEC CAT, GDPR, CCPA, etc.). In the same example, the external system 203 may be affiliated with a particular institution, such as a financial institution, educational institution, government institution, corporate entity, or other institutions. The compliance tool 229 can receive cyber compliance parameters, policies, and other trigger-able and/or monitor-able thresholds for which a system user, or the like, would like to monitor. The compliance tool 229 can be configured to render, on a webpage, relevant cyber compliance data (e.g., presented as charts), detected cyber compliance trends, and cyber compliance violations. The compliance tool 229 can cause the alert service 221 to generate alerts, for example, in response to detection of a potential cyber compliance violation or to notify a user of updates to compliance policies.

The trigger tool 231 can process inputs for controlling triggers and thresholds that are used by the system to identify events, activities, patterns, and trends in one or more external systems 203 that may be anomalous and/or fraudulent. In one example, the trigger tool 231 receives trigger selections from a system user and/or a system contributor for configuring triggers based on logins from high-risk countries, based on logins sourced from former employee IP addresses, based on activity from accounts occurring outside of typical active intervals, etc. The monitoring system 200 can receive or collect data from external systems 203 based at least in part on one or more triggers with which the external systems 203 are associated. The trigger tool 231 can identify anomalies or fraudulent patterns across or more systems, such as, for example, identifying that an ATM withdrawal is fraudulent in response to determining an application on a smartwatch identifies the user is engaged in a workout activity, sleeping, and/or at another location. The application on the smartwatch may verify that vital signs associated with a current user match profile data for that user to determine the smartwatch data has a higher level of trust associated therewith. The system may determine that customer service call is fraudulent in response to disparities in metadata associated with the smartwatch when compared to metadata for the customer service call.

The portals 222 can include, but are not limited to, a cyber-fraud portal 233, an electronic delivery systems (EDS) service portal 235, an application database service portal 237, a core/ancillary systems (CAS) service portal 239, an alert portal 241, and a ticket portal 243. The portals 222 can be accessible via a platform, such as a web-based application. The platform can include user interfaces (associated with each portal 222) configured for receiving and processing inputs to control processes and functions of various elements of the monitoring system 200.

The cyber-fraud portal 233 can generate and/or cause the display of interactive summary charts and tables of potentially fraudulent events detected by the present system (e.g., in response to monitoring a customer system with respect to one or more triggers). The EDS service portal 235 can generate and/or cause the display of interactive summary graphics, tables, and charts of potentially fraudulent electronic delivery system activities. The application database service portal 237 can generate and/or cause the display of interactive summary graphics, tables, and charts of potentially fraudulent application database activities. The CAS service portal 239 can generate and/or cause the display of interactive summary graphics, tables, and charts of potentially fraudulent core and ancillary systems activities. The alert portal 241 can generate and/or cause the display of one or more user interfaces comprising alerts (e.g., generated by an alert service 221 or received from an external system 203) and related information, such as, for example, interactive charts, tables, and graphics describing detected activities that caused or contributed to the generation of one or more alerts. The ticket portal 243 can generate and/or cause the display of interactive summary charts, tables, and graphics presenting historical and ongoing tickets (e.g., potential fraud incidents). The ticket portal 243 can cause displays of tasks and task schedules (e.g., for responding to tickets, for performing cyber compliance actions, etc.).

With reference to FIG. 2C, shown is an additional embodiment of the monitoring system 200. The monitoring system 200 in FIG. 2C illustrates exemplary interactions of one or more customer fraud teams and subject matter experts with the monitoring system 200.

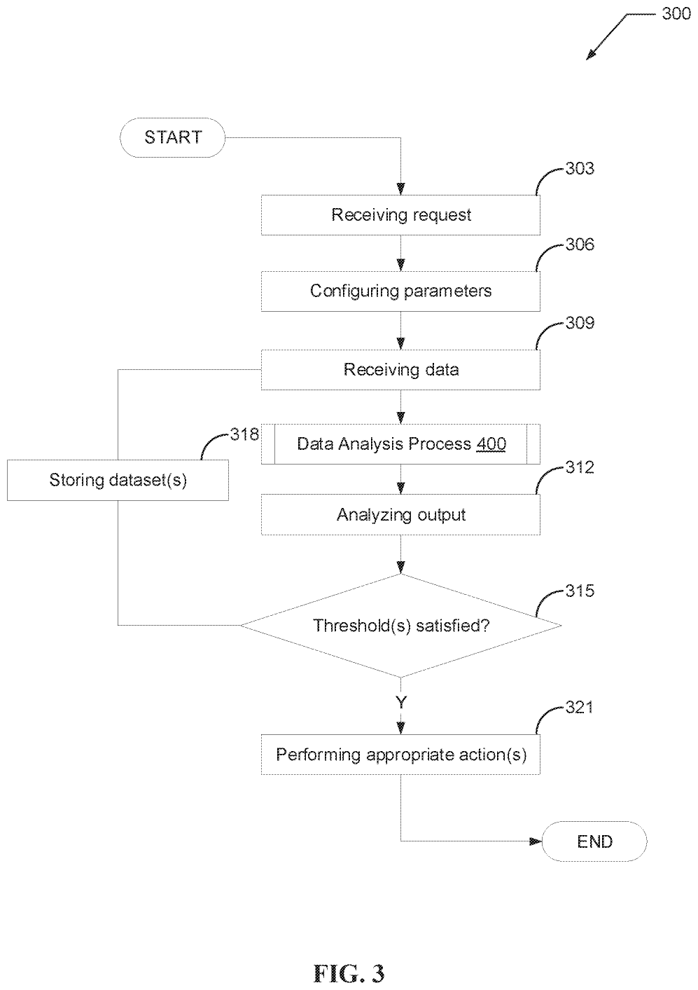

With reference to FIG. 3, shown is a fraud detection process 300. As will be understood by one having ordinary skill in the art, the steps and processes shown in FIG. 3 (and those of all other flowcharts and sequence diagrams shown and described herein) may operate concurrently and continuously, are generally asynchronous and independent, and are not necessarily performed in the order shown.

At step 303, the process 300 includes receiving one or more requests. For example, the system can receive a request to configure fraud monitoring processes for one or more external system 203, such as an ATM system and a mobile banking system. The request can be received as one or more inputs to a monitor application 216 or a portal 222. The request can include an identifier and credentials, such as a username, password, or public key. Based on the identifier, the system can identify a particular user account and the system can retrieve account data 207 used to authenticate the credentials. The request can include metadata, such as, for example, an IP address, MAC address, and location data. The metadata can be compared to stored data, such as a verified IP address or predefined location, to verify an identity of the device from which the request was received. The request can include selections and other data for configuring various triggers, thresholds, and other aspects of fraud monitoring and detection. For example, the request can include a selection for access hours of one or more users of an electronic teller system, the access hours being used to configure triggers for detecting anomalous attempts to access the teller system (e.g., outside of access hours).

In another example, the request can include historical transaction data comprising times and locations in which a customer accessed an ATM system, a mobile banking system, and a customer service system. In some embodiments, data can automatically be retrieved based on the request. For example, in response to a request to configure fraud detection services for a plurality of user accounts of a bill pay system and an account opening system, the monitoring system 200 can automatically retrieve historical data associated with each of the plurality of users. In the same example, compliance policies or other configuration profiles can be automatically accessed or downloaded (e.g., via a compliance tool 329).

At step 306, the process 300 includes configuring parameters, such as, for example, triggers and threshold for controlling fraud analysis and prediction processes. The parameters can be configured automatically and/or manually (e.g., based on selections and/or data included in a request). Automatic configuration can be performed, for example, based on compliance policies, configuration profiles, and other best-practice settings that are associated with one or more external systems 203 for which fraud monitoring and detection is requested. In one example, a request is received to configure fraud detection processes for a wire transfer system and a data warehouse in which customer account data is stored. In this example, the compliance tool 229 automatically retrieves a policy profile for configuring wire transfer fraud triggers and thresholds, and retrieves a second policy profile for configuring data warehouse monitoring triggers. In the same example, the policy profile can include thresholds for transfer amounts and destinations, such as amounts approaching limits for federal reporting guidelines and wire transfer destinations associated with previous fraud activities. The second policy profile can include, for example, protocols for controlling access to the data warehouse, such as historical access patterns, workflows, and employee account behavior (e.g., hours of operation, logs of accounts accessed or customers assisted, etc.).

In another example, a request includes a plurality of networking addresses and locations (e.g., countries, regions, etc.). In this example, a plurality of triggers can be configured such that detection of transaction activity associated with any of the plurality of networking addresses or locations causes the monitoring system 200 to determine that a fraud event is likely to have occurred. In another example, based on a log of call center activities, an expected location, time, and communication method can be configured for each user account with which the call center system is associated. In the same example, a threshold for evaluating tabulations of credential change attempts is configured. Continuing the example, the triggers and thresholds can be used to determine that a high volume of credential change attempts from an atypical communication method may indicate an increased likelihood of a fraud event.

At step 309, the process 300 includes receiving data from one or more external systems 203. The data can be received substantially continuously and can be stored as monitoring data 209. In one example, the data includes transactional data, such as a time-series record of transaction amounts, locations, and methods by which transactions were requested (e.g., telephone, web-application, mobile application, etc.). In the same example, the data includes networking information, such as IP addresses and credential data that identifies one or more computing devices 206 by which transactions were initiated. In another example, the data includes call center activity logs and mobile banking application logs. The call center activity logs can include, for example, data describing a source, frequency, and type of requested services, such as password resets and balance inquiries, which may provide indications of social engineering-based tactics for enabling future fraud events. The mobile banking application logs can include, for example, a time-series record of login attempts and login failures, as well as metadata identifying a computing device 206 used in each attempt, a location with which each attempt is associated, and a network service provider with which communications to the mobile banking application are associated.

In another example, the received data comprises loan application data. In this example, the loan application data includes location and networking data associated with a computing device 206 with which a loan application system was accessed. The location data can include GPS coordinates and the networking data can include an IP address. The loan application can include user data, such as an identifier or name of an individual for which the loan application was requested.

The process 300 can include performing one or more data analysis processes 400 using the received data and other data, such as historical data, and security and compliance profiles. By the process 400, various analytical outputs can be generated including, but not limited to, fraud likelihood scores, determinations of anomalous activity, and identifications of particular fraud behaviors.

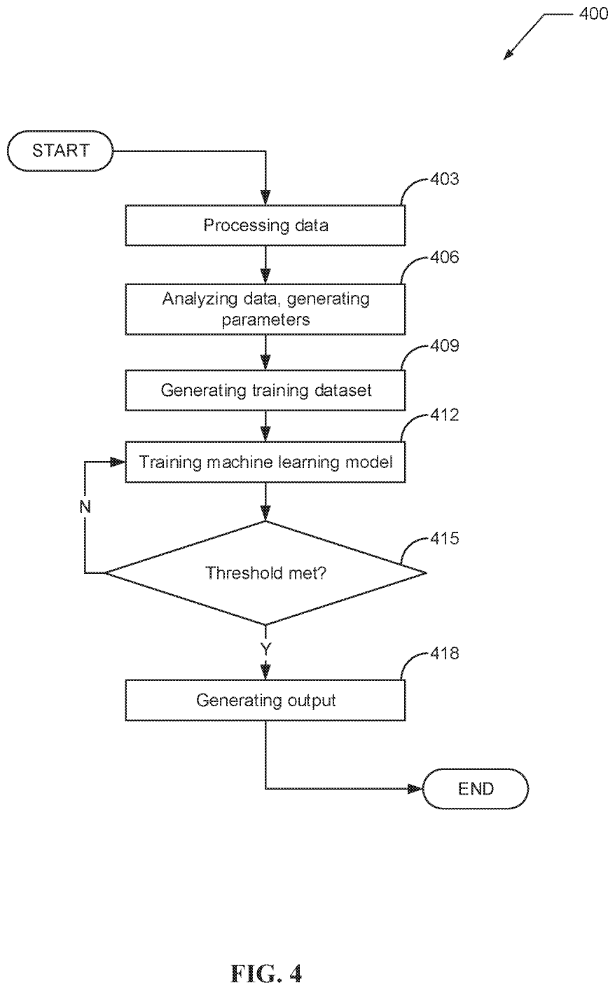

At step 312, the process 300 includes analyzing outputs, such as, for example, an output from a data analysis process 400 (FIG. 4). Output analysis can include, for example, comparing the output to one or more thresholds, triggers, and/or historical patterns. For example, the system can compare a score for predicting the likelihood of an unauthorized access attempt to a predetermined unauthorized access threshold. In another example, a fraud likelihood score can be compared to a plurality of thresholds for determining a threat level. In this example, the fraud likelihood can range from 0-10 and each increment on the scale can represent an instance in which anomalous transactional activity was detected (e.g., unrecognized IP address, login failure, atypical transfer amount, etc.). In the same example, the plurality of thresholds can include a no threat threshold between about 0-2 instances, a low-level threat threshold between about 3-5 instances, a mid-level threat threshold between about 6-8, and a high-level threat threshold between about 9-10 instances. In some embodiments, the system can determine one or more triggers for potential fraud and determine a weighted score based on each of the potentially fraudulent activities identified. In one example, various trigger thresholds may be configured lower (e.g., 75^{th} percentile) such that the combination of multiple lower-likelihood fraudulent exceeds a predefined threshold based on a weighted score of the combination.

At step 315, the process 300 includes determining if one or more thresholds are met. In response to determining that one or more thresholds are not met, the process can proceed to step 318. In response to determining that one or more thresholds are met, the process 300 can proceed to step 321. The thresholds can be scale-based (e.g., an increasing likelihood score corresponding to an increasingly greater likelihood of fraud) or can be Boolean-based. For example, a threshold for determining unauthorized access attempts can be Boolean-based such that any unrecognized IP address (e.g., as identified in mobile banking activity logs) causes the threshold to be met.

At step 318, the process 300 includes storing one or more datasets. The dataset can include one or more of, but is not limited to, output (e.g., as generated from a data analysis process 400), a machine learning model, training datasets, and input datasets provided to the machine learning model. The dataset can be labeled based on a likelihood score or other output and the labeled dataset can be used to train machine learning models for improved performance. In some embodiments, the dataset can be automatically and/or manually analyzed and labeled. For example, a dataset for which a fraud event was not predicted but in which fraud event was determined to have occurred is labeled as a fraudulent dataset. In this example, the fraudulent dataset is used to train and improve machine learning models to more accurately predict fraud events.

At step 321, the process 300 includes performing one or more actions. The actions can include, but are not limited to, generating an alert, locking one or more user accounts associated with one or more external systems 203, enforcing a credential and/or configuration change for a user account or computing device 206, initiating a dual authentication or other identity verification process, flagging one or more user accounts for manual review, and updating one or more user interfaces.

In one example, the monitoring system 200 determines that a particular account accesses an ATM in a first location and, within a particular duration of the ATM access event, requests access to log into a mobile banking application from a second location. By the process 300, the monitoring system 200 can determine that it would have been physically impossible for a user to, within the particular duration, access the ATM at the first location and travel to the second location. For example, the monitoring system 200 computes a fraud event likelihood score based on the determination and compares the score to a predetermined threshold. In this example, the predetermined threshold is determined to be met and various actions are initiated. Continuing the same example, the alert service 221 transmits an electronic alert to a user account associated with a fraud department of the bank with which the particular account is associated. The alert service 221 can initiate an API call to an administrator account of the mobile banking application and transmit a message indicating the potential fraud activity and identifying the particular user. The API call can include a command that causes the particular account to be locked from accessing the mobile banking application.

In another example, over a predetermined time period (e.g., several weeks), the monitoring system 200 analyzes logs of calls to a customer service system, the calls being associated with a particular account. In the same example, the monitoring system 200 can determine that a mobile banking system received commands associated with the particular account, the commands including password reset requests, failed login attempts, and username lookups. Continuing this example, the monitoring system 200 computes a fraud event likelihood, such as a social engineering score, and the score is compared to a predetermined threshold. The score can be determined to meet the predetermined threshold and the monitoring system 200 can transmit an alert to the customer service system and a computing device 206 with which the particular account is associated. The monitoring system 200 can initiate a dual authentication and credential change process for the particular account, thereby forcing a user to update login information and subjecting future interactions with the customer service system and/or mobile banking systems to increased security protocols.

In another example, the monitor 200 system analyzes a pattern of activity processed at a loan application system in response to commands from a particular account. The monitoring system 200 can determine that one or more commands are associated with locations included in a blacklist of fraud-prevalent regions. The monitoring system 200 can further determine that an origin IP address associated with a command is included in a list of known IP addresses with which historical fraud events are associated. The monitoring system 200 can generate a fraud likelihood score and compare the score to one or more thresholds. The monitoring system 200 can determined that the threshold is met and can transmit a command to the loan application system. The command can cause the loan application system to enforce a more detailed loan application process in response to future requests from the particular account, thereby providing increased verification protocols for authenticating a user with which the particular account is associated. In response to the command, the system can transmit an alert to a computing device 206 with which the particular account is associated. The alert can prompt a user to enable dual-authentication settings and/or cause the computing device 206 to automatically initiate a configuration change or update to a software application with which the loan application system is associated.

With reference to FIG. 4, shown is a data analysis process 400. At step 403, the process 400 includes processing data. The data can include, for example, monitoring data 209. Processing the data can include, but is not limited to, removing null values, imputing values, removing outlier data, and performing data deduplication. Processing the data can include aggregating data from multiple sources. For example, monitoring data 209 from a plurality of external systems can be aggregated based on associated timestamps such that a time-series record of activities occurring across multiple external systems 203 is generated.

At step 406, the process 400 includes analyzing data and generating one or more parameters. Data analysis can include, but is not limited to, identifying atypical and/or suspicious patterns, correlations, trends, and behaviors. The data analysis may include comparing the monitoring data 209, or a subset thereof, to historical fraudulent and/or non-fraudulent data to determine potential (dis)similarities. The data analysis can include retrieving threat data (e.g., via the threat tool 225), such as a blacklist of IP addresses and locations, and determining if the monitoring data 209 is substantially similar to the threat data.

The data analysis can include performing various computations to identify “impossible” activities. For example, a physical transaction event, such as an ATM or in-person teller transaction, is associated with a first location and a first timestamp, and a digital transaction event, such as a balance inquiry to a mobile banking system, is associated with a second location and a second timestamp. In this example, the monitoring system 200 can compute a distance between the first location and the second location, and an estimated time required to travel therebetween. In the same example, the monitoring system 200 can compare the estimated time to a duration between the first and second timestamps. Continuing this example, the monitoring system 200 determines that the estimated time is greater than the duration and determines that impossible, and thus potentially fraudulent, activity is occurring.

The following paragraphs provide an exemplary scenario of various fraud detection analyses. In one example, the monitoring system 200 receives data associated with a recent administrative login event in which the login event was followed by an administrative adjustment of a particular interest-bearing account's interest rate. In the same example, the monitoring system 200 analyzes the administrative events and an associated administrator account, and identifies that the administrator account's most recent preceding login event was from a first IP address and was performed via a registered computing device 206. The monitoring system 200 also determines that the administrator's most recent login event was from a second IP address and was performed using an unregistered computing device 206. The EDS monitoring service 213 retrieves information related to the login event, and analyze electronic banking data for activity or events that may be correlated with the activity detected by the application database service 215. The EDS monitoring service 213 identifies an irregularly large e-banking fund transfer that occurred within a predefined time period following the detected administrative event.

Continuing the above example, the EDS monitoring service 213 analyzes employee user activities to determine if any employees performed account balance lookups on the particular interest-bearing account prior to and/or immediately following the detected administrator event. The EDS monitoring services determines that a particular bank employee (for example, an assistant to the administrator) performed an account balance lookup on the particular interest-bearing account. The compliance tool 229 determines that the use of an unregistered computing device 206 violates a particular compliance policy (e.g., on which the employees have been educated). The EDS monitoring service 213 evaluates one or more customer accounts to determine if any customer accounts made or received a transfer from the particular interest-bearing account (e.g., immediately prior to or following the administrative change event). The EDS monitoring service determines that a particular customer account made a transfer to the particular interest-bearing account. The above-described determinations are stored as a time-series record of potentially fraudulent actions, patterns, and behaviors. As further described herein, one or more datasets can be generated comprising the various determinations and associated data, and the one or more datasets can be provided as an input to a machine learning model for predicting a likelihood of fraud event occurrence.

Steps 409-415 relate generally to a process for training a machine learning model to perform various actions including, but not limited to, identifying potentially fraudulent activities and behaviors based on an input dataset, classifying an input dataset (e.g., comprising monitoring data 209) as potentially fraudulent, and computing a fraud likelihood score. In some embodiments, the steps 409-415 are omitted.

At step 409, the process 400 includes generating a training dataset. In one example, the training dataset includes historical monitoring data 209 that excludes fraudulent activities. In the same example, a second training dataset is generated that includes one or more instances of fraudulent activity. In the same example, the first and second training datasets can be used to train a machine learning model, such as a perceptron, to automatically classify monitoring data 209 as potentially fraudulent or authentic, or to generate a score for measuring a likelihood of the monitoring data 209 being associated with a fraud event. In another example, the training dataset includes specific fraud types, such as impossible transactional data, anomalous access logs, or customer service records associated with social engineering attempts. In this example, the fraud-specific training dataset can be used to train a machine learning model to identify specific fraud behavior and/or to determine additional patterns that may be indicative of fraud events. Generating the training dataset can include automatically and/or manually labeling data. For example, a subset of a training dataset can be labeled as fraudulent and a second subset can be labeled as authentic. Data labels can be used, for example, in supervised or semi-supervised learning processes for training one or more machine learning models. In other embodiments, one or more training datasets, or subsets thereof, are unlabeled.

At step 412, the process 400 includes training a machine learning model. The machine learning model can include, but is not limited to, decision trees, random forest models, neural networks, or classification models (e.g., naïve bayes, support vector, or logistic regression models). The machine learning model can be configured to apply one or more learning techniques including, but not limited to, supervised learning, unsupervised learning, reinforcement learning, semi-supervised learning, self-supervised learning, multi-instance learning, and other suitable learning techniques. Training the machine learning model can include generating a plurality of parameters and weight values, each weight value for determining a contribution level that a corresponding parameter provides to an output of the machine learning model. Non-limiting examples of parameters include, but are not limited to, metrics of pattern similarity between monitoring data 209 and historical data, a count of instances in which an impossible activity occurred, a count of login failure instances, a count of credential change requests, a mapping of network addresses from which various requests and/or inputs were received, employment data-based metrics (e.g., such as operating hours, locations, actions, and behaviors), and user data-based metrics (e.g., such as hours of access, typical transfer amounts, and other activity records or patterns).

Training the machine learning model can include executing the model on one or more training datasets to generate an output. In one example the machine learning model is trained using a supervised learning technique in which the machine learning model is executed using a labeled training dataset (comprising labeled inputs and known outputs). In this example, the output of the machine learning model can be compared to the known output and, based on the comparison, an accuracy or error metric can be computed. Training the machine learning model can include adjusting one or more parameters or parameter weight values to improve an accuracy metric or reduce an error metric. Training can be performed continuously, for example, until a predetermined accuracy or error threshold is met.

At step 415, the process 400 includes determining whether one or more thresholds are met, such as, for example, accuracy or error thresholds. In response to determining that the threshold is met, the process 400 can proceed to step 418. In response to determining that the threshold is not met, the process can proceed to step 412 and the machine learning model can be trained, adjusted, and optimized towards improving the accuracy of the output.

At step 418, the process 400 includes generating output, such as, for example, a classification of an input dataset as authentic or potentially fraudulent, or one or more prediction scores for determining a likelihood of fraud event occurrence. In one example, an input dataset is generated comprising processed monitoring data 209 and other data, such as account data 207 and configuration data 211 corresponding to one or more external systems 203 with which the monitoring data 209 is associated. A plurality of input datasets can be generated. For example, a plurality of input datasets can include an electronic delivery systems dataset, an application database dataset, a core/ancillary systems dataset, and a general ledger/accounts service dataset. In this example, one or more trained machine learning models are executed on each dataset to generate a plurality of outputs, such as a plurality of likelihood scores. Continuing this example, an additional machine learning model process can be executed on the plurality of likelihood scores to generate a combined likelihood score. The combined likelihood score can be generated, for example, by weighing each of the plurality of likelihood scores and combining the weighted scores to generate the combined likelihood scores. The weight values can be optimized values generated from a machine learning model training process executed on historical monitoring data 209 or other data. The combination of weighted likelihood scores can include, for example, summing or multiplying the weighted scores, comparing the weighted likelihood scores to one or more calibration scales, or by applying one or more algorithms.

FIG. 5A shows an exemplary cyber-fraud portal 233A according to one embodiment. The cyber-fraud portal 233A can include a user interface 501. The user interface 501 can include one or more visualizations 503A-D. The one or more visualizations 503A-D can be generated by the monitoring system 200 (e.g., by one or more services or a monitor application 216) based on monitoring data 209 and various processes by which the monitoring data 209 is analyzed. For example, the visualization 503A includes a bar graph summarizing potential fraud alerts generated at an alert service 221. In this example, the alerts include labels 505 that can be rendered based on configuration data 211, such as a predefined list of customized fraud thresholds (e.g., each label 505 being associated with a specific activity or pattern of activities demonstrated by monitoring data 209). In another example, the visualization 503B includes a line graph summarizing potential fraud alerts generated for a plurality of external systems 203 (not shown). In this example, the visualization 503B includes a legend 507 that indicates each external system 203 with which the visualization 503B is associated. The user interface 501 can be updated, for example, in response to inputs from a user. In one example, the visualization 503B can be rendered based on an input comprising a selection for a particular set of external systems 203.

In another example, the visualization 503C includes a fraud activity table in which counts of potentially fraudulent activity are displayed. In this example, the visualization 503C includes counts of login actions originating from potentially high-risk countries, the high-risk countries being determined based on data feeds from a threat tool 229. In another example, the visualization 503D includes a second fraud activity table comprising a log of user accounts with which potentially fraudulent login actions are associated, the log comprising a count of the login actions for each user account.

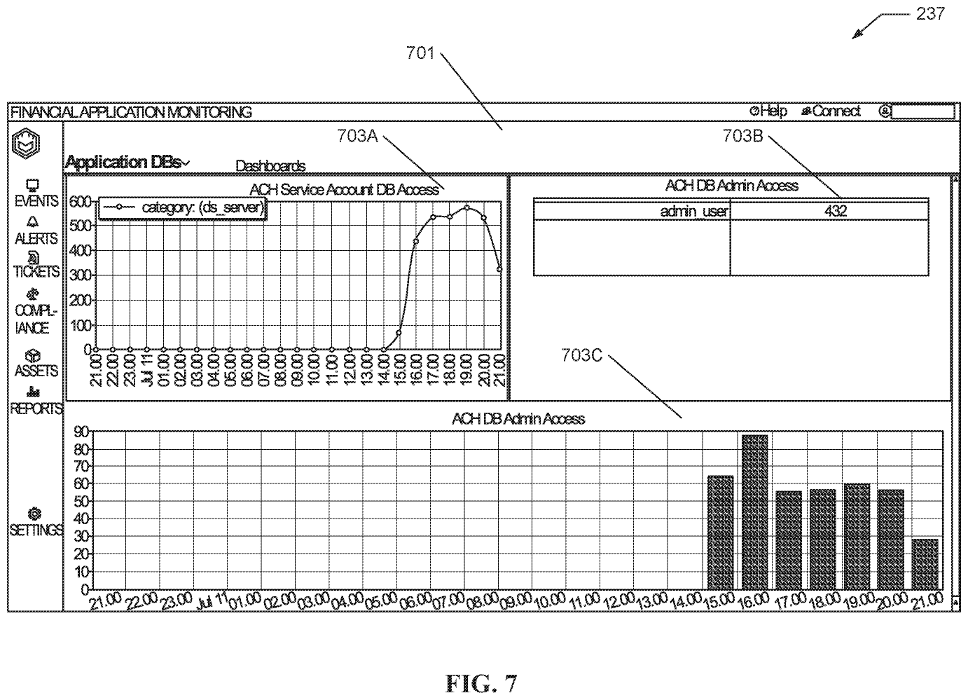

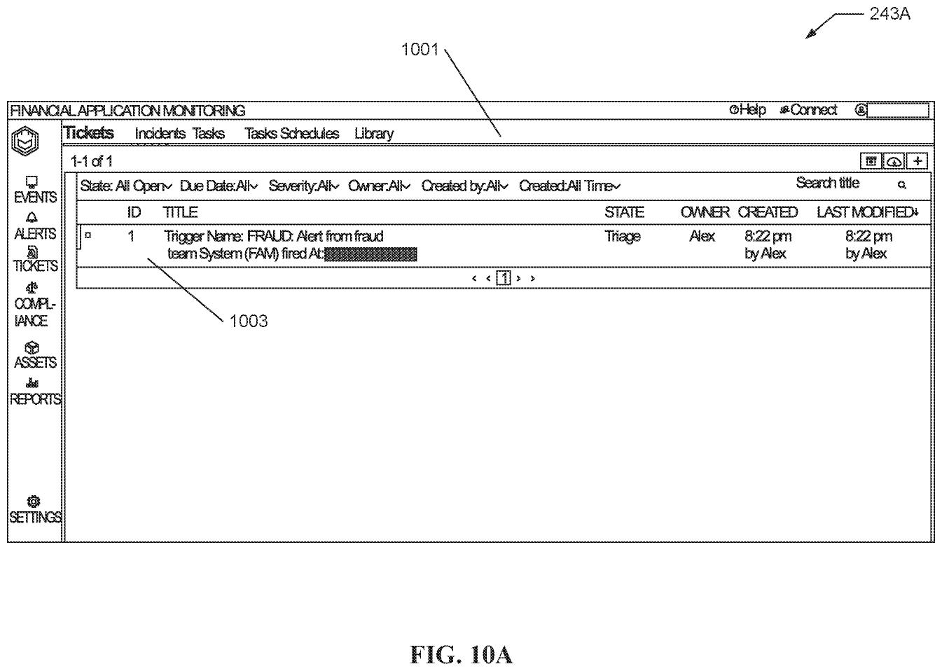

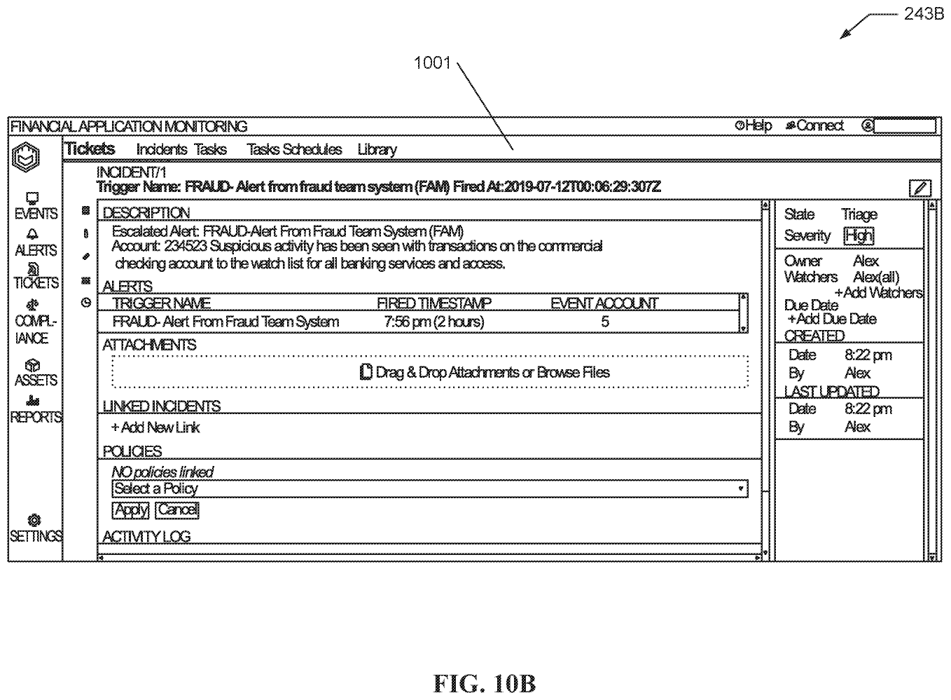

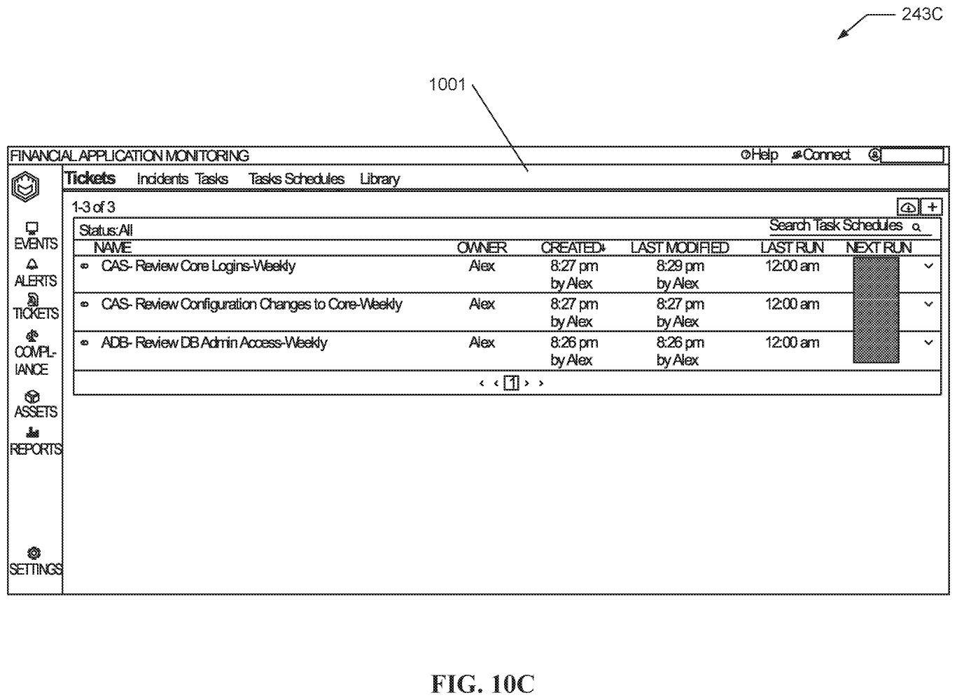

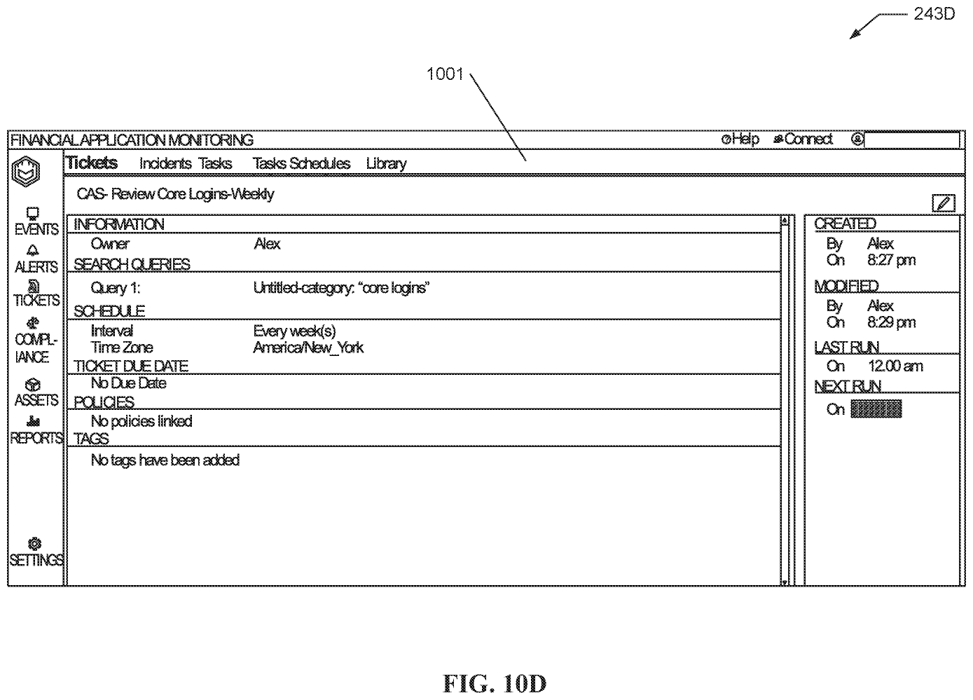

FIG. 5B shows an exemplary cyber-fraud portal 233B according to one embodiment. The user interface 501 can include a window 509 for navigating through various portals and user interfaces. For example, a selection at the window 509 causes an application database portal 237 (FIG. 7) to be accessed and an associated user interface 701 to be rendered. The user interface 501 can include one or more fields 513A-F for initiating the rendering of various category-specific interfaces or for accessing other portals and user interfaces associated therewith. For example, a selection of the field 513A causes the user interface 501 to be updated to include data associated potential fraud events (e.g., anomalous transaction patterns, suspicious login events, etc.). In the same example, a selection of the field 513B causes the under interface 501 to be updated with data associated with alerts generated or received at the monitoring system 200. A selection of the field 513C can cause a ticket portal 243A (FIG. 10A) to be accessed.

Selection of the field 513D can cause display of data with which a compliance tool 229 is associated. A Selection of the field 513F can cause the system to display of a user interface for controlling and initiating report generation. Reports can include, for example, summaries of monitoring data 209 and associated analyses for a predetermined time interval (e.g., 1 day, 1 week, 1 month, etc.). In one example, a report includes one or more visualizations, such as a daily log comprising timestamps and labels with which each detected fraud event is associated.

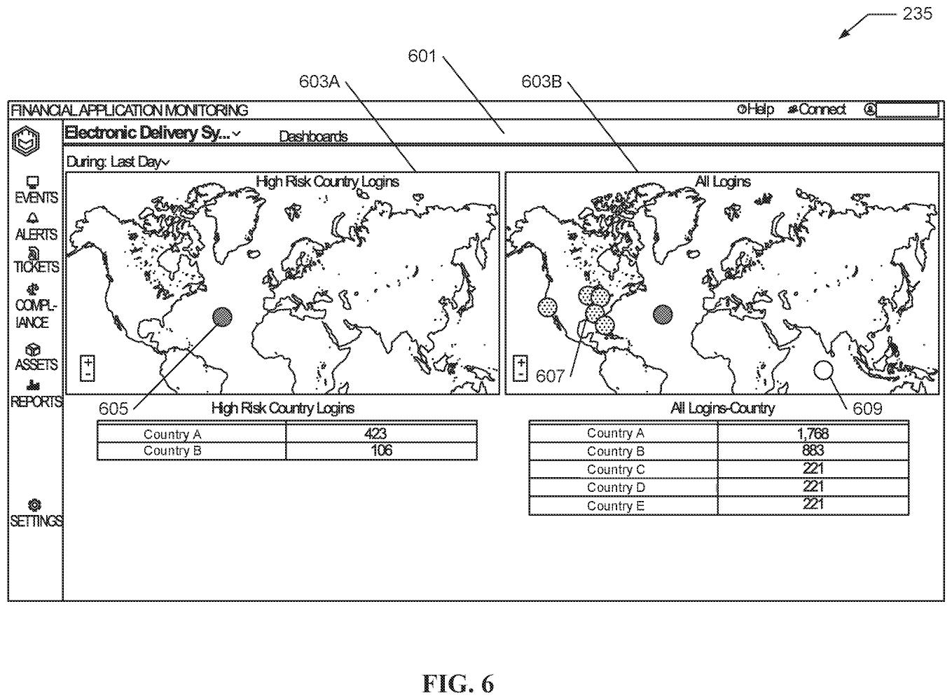

FIG. 6 shows an exemplary electronic delivery systems (EDS) portal 235 according to one embodiment. The EDS portal 235 can include a user interface 601 on which various data associated with the EDS service 213 is displayed. The user interface 601 can include a map 603A, 603B on which various detected activities and other data can be rendered. In one example, the map 603A includes a world map on which a fraud event marker 605 is rendered. In this example, the event marker 605 is associated with detected login activity originating from a Location A that was determined to be a high-risk region for fraudulent activity. In the same example, the map 603B includes a world map on which the fraud event marker 605 is rendered, along with one or more event markers 607, 609. In this example, the event marker 607 corresponds to detected events for which a low likelihood of fraud was determined, and the event marker 609 corresponds to detected events for which a mid-level likelihood of fraud was determined. Continuing the example, the low-, mid-, and high-level likelihood event markers can be associated with likelihood prediction scores and the type of event marker can be determined based on comparing the corresponding prediction score to one or more thresholds and/or a calibration scale.

FIG. 7 shows an exemplary application database portal 237 according to one embodiment. The application database portal 237 can include a user interface 701 on which various data and information associated with the application database service 215 can be rendered. The user interface 701 can include one or more visualizations 703A-C. In one example, the visualization 701A is a line graph that displays access attempts for a particular external system 203, such as an ACH service account database. In another example, the visualization 701B is a table comprising a count of database access attempts with which a particular administrative account is associated. In another example, the visualization 703C is a histogram displaying a frequency of administrator-level database access requests that were received within a predetermined interval.

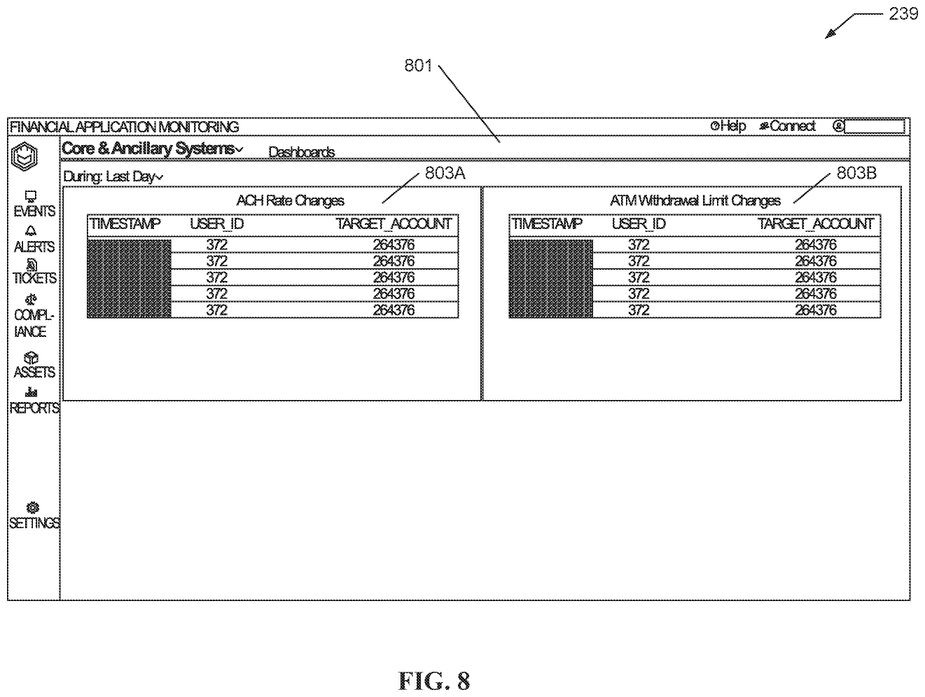

FIG. 8 shows an exemplary core/ancillary systems (CAS) portal 239 according to one embodiment. The CAS portal 239 can include a user interface 801 on which various data and information associated with the CAS service 217 can be rendered. The user interface 801 can include one or more visualizations 803A-B. In one example, the visualization 803A includes an activity log summarizing detected ACH rate changes applied to an account (e.g., as authorized by a particular employee) at a core banking system. In this example, the visualization 803A provides a summary of events analyzed by the monitoring system 200 and determined to be potentially indicative of fraudulent conduct (e.g., approving unauthorized rate changes). In another example, the visualization 803B includes an activity log summarizing detected ATM withdrawal limit changes applied to an account at an ATM system.

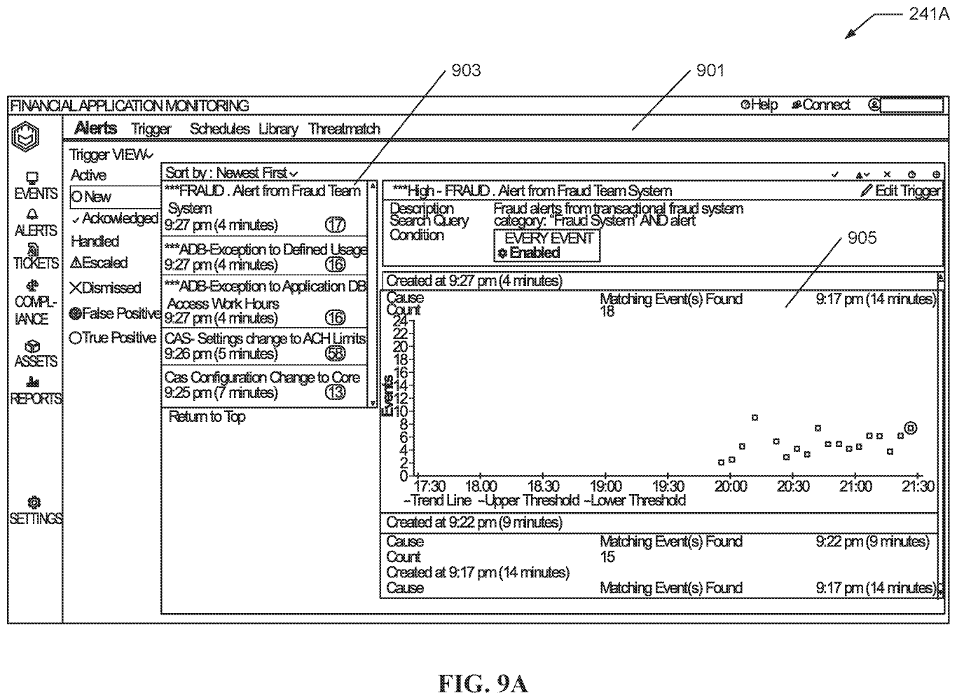

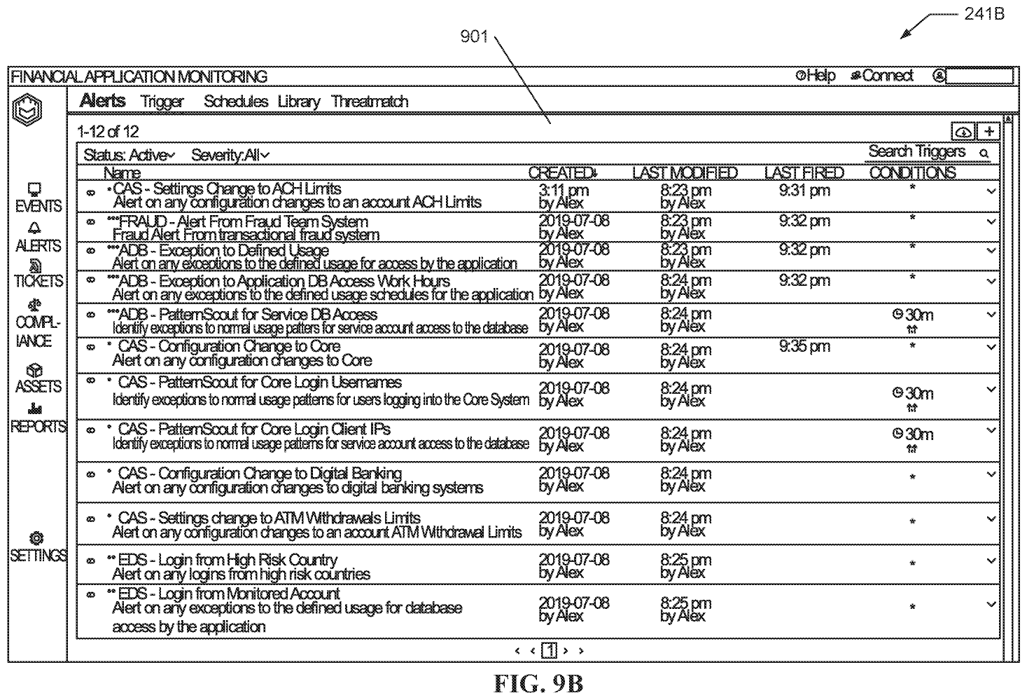

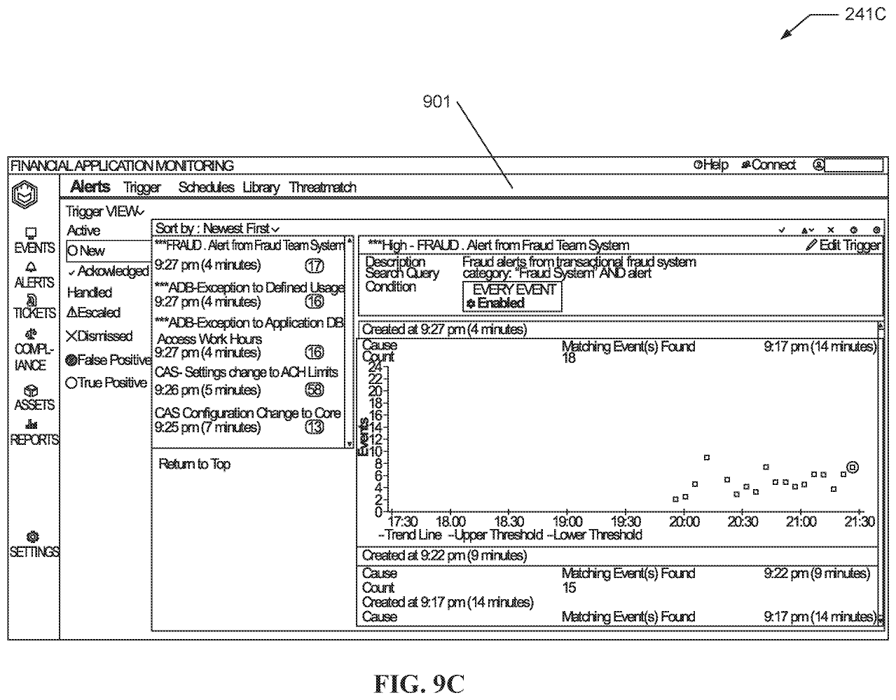

FIG. 9A shows an exemplary alert portal 241A according to one embodiment. The alert portal 241A includes a user interface 901 on which various data and information associated with the monitoring system 200 (e.g., in particular, the alert service 221) can be rendered. The user interface 901 can include a log 903 comprising various detected events and/or alerts generated based on the detection of an event (e.g., potentially fraudulent activities). The log 903 can be updated, for example, in response to the alert service 221 transmitting an alert. The user interface 901 can include one or more visualizations 905. In one example, the visualization 905 includes a scatter plot displaying a count of potential fraud events detected within particular time intervals (e.g., 1 hour, 1 day, 1 week, etc.). The visualization 905 can be updated, for example, in response to a search query. The user interface 901 can include a search field 907 configured for receiving various search inputs including, but not limited to, dates, triggers, accounts, system labels, and fraud event labels.

FIG. 9B shows an exemplary alert portal 241B according to one embodiment.

FIG. 9C shows an exemplary alert portal 241C according to one embodiment.

FIG. 10A shows an exemplary ticket portal 243A according to one embodiment. The ticket portal 243A includes a user interface 1001 on which various data and information associated with the monitoring system 200 (e.g., in particular, the ticket system 223) can be rendered. The user interface 1001 can include, for example, a log 1003 comprising summaries of one or more tickets. The user interface 1001 can be updated to include additional details with which the ticket is associated.

FIG. 10B shows an exemplary ticket portal 243B according to one embodiment. The user interface 1001 can include a detailed log 1005 that is generated and rendered, for example, in response to a selection of an entry in a log 1003 (FIG. 10A). The detailed log 1005 can include a summary 1007 that describes one or more potentially fraudulent activities (e.g., as provided in a ticket or detected by the monitoring system 200). For example, based on a fraud detection process, the summary 1007 can be generated and can describe that “suspicious activity has been seen with transactions on the commercial checking account.” The detailed log 1005 can provide additional information including, but not limited to, timestamps, associated triggers and thresholds, attachments (e.g., such as one or more rules which were potentially violated), links to other tickets, policies with which the ticket is associated, and an activity log comprising actions taken in response to the ticket (e.g., such as transmitting an alert, locking a particular account, etc.).

FIG. 10C shows an exemplary ticket portal 243C according to one embodiment.

FIG. 10D shows an exemplary ticket portal 243D according to one embodiment.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media that can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid-state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general-purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such connection is properly termed and considered a computer-readable medium. Combinations of the above should also be included within the scope of computer-readable media. Computer-executable instructions comprise, for example, instructions and data which cause a general-purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed systems may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed system are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the systems are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the system is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

Aspects, features, and benefits of the claimed devices and methods for using the same will become apparent from the information disclosed in the exhibits and the other applications as incorporated by reference. Variations and modifications to the disclosed systems and methods may be effected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the devices and methods for using the same to the precise forms disclosed. Many modifications and variations are possible in light of the above teaching.

The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope. Accordingly, the scope of the present devices and methods for using the same is defined by the appended claims rather than the foregoing description and the exemplary embodiments described therein.

What is claimed is:

1. A method comprising:
receiving, via at least one computing device, transactional data from a first computing system, the transactional data comprising data describing at least one transaction and user identifying information;
determining, via the at least one computing device, that the transactional data corresponds to a particular user account;
receiving, via the at least one computing device, mobile device data associated with the particular user account;
determining, via the at least one computing device, a likelihood of a fraudulent event based on a comparison of the transactional data to the mobile device data; and
in response to the likelihood of the fraudulent event exceeding a predefined threshold, performing, via the at least one computing device, a remedial action.

2. The method of claim 1, wherein the transactional data comprises a first geographic position associated with the at least one transaction and the mobile device data comprises a second geographic position associated with a mobile device.

3. The method of claim 2, wherein determining the likelihood of the fraudulent event comprises: determining a distance between the first geographic position and the second geographic position, wherein the likelihood of the fraudulent event is based at least in part on the distance.

4. The method of claim 1, wherein determining the likelihood of the fraudulent event comprises: determining a difference between a first time that the at least one transaction occurred and a second time that the mobile device data was captured, wherein the likelihood of the fraudulent event is based at least in part on the difference between the first time and the second time.

5. The method of claim 1, further comprising comparing the user identifying information and the mobile device data to a customer service log associated with the particular user account.

6. The method of claim 5, further comprising determining a likelihood of fraudulent activity based at least in part on the comparison between the customer service log, the user identifying information, and the mobile device data.

7. The method of claim 1, wherein determining the likelihood of the fraudulent event comprises executing a machine learning model on the transactional data and the mobile device data.

8. The method of claim 7, wherein the machine learning model is trained to differentiate between non-fraudulent and fraudulent activity using a training dataset, wherein the training dataset comprises:
a first subset comprising historical transactional data that is not associated with fraudulent activity; and
a second subset that excludes the first subset and comprises the historical transactional data that is associated with fraudulent activity.

9. A system comprising:
a data store; and
at least one computing device in communication with the data store, the at least one computing device being configured to:
receive transactional data from a first computing system, the transactional data comprising data describing at least one request and user identifying information;
determine that the transactional data corresponds to a particular user account;
receive mobile device data associated with the particular user account;
determine a likelihood of a fraudulent event based on a comparison of the transactional data to the mobile device data; and
in response to the likelihood of the fraudulent event exceeding a predefined threshold, perform a remedial action.

10. The system of claim 9, wherein;
the request comprises a service provider identifier associated with a computing device from which the request was received; and
the mobile device data comprises a second service provider identifier associated with a second computing device from which the mobile device data originated.

11. The system of claim 10, wherein the at least one computing device is further configured to determine that the service provider identifier does not match the second service provider identifier, wherein the likelihood of the fraudulent event is based at least in part on the determination.

12. The system of claim 9, wherein the remedial action comprises enforcing a dual-authentication setting for the particular user account.

13. The system of claim 9, wherein the at least one computing device is further configured to compare the user identifying information and the mobile device data to an administrator access log associated with the first computing system.

14. The system of claim 13, wherein the at least one computing device is further configured to determine a likelihood of fraudulent activity based at least in part on the comparison of at least two of: the administrator access log, the transactional data, and the mobile device data.

15. A non-transitory computer-readable medium embodying a program that, when executed by at least one computing device, causes the at least one computing device to:
receive service data from a first computing system, the service data comprising a service log and user identifying information;
determine that the service data corresponds to a particular user account;
receive mobile device data associated with the particular user account;
determine a likelihood of a fraudulent event based on a comparison of the service data to the mobile device data; and
in response to the likelihood of the fraudulent event exceeding a predefined threshold, perform a remedial action.

16. The non-transitory computer-readable medium of claim 15, wherein:
the service log comprises a credential reset request associated with a first time; and
the mobile device data comprises an application access log associated with a second time.

17. The non-transitory computer-readable medium of claim 16, wherein the program further causes the at least one computing device to determine a difference between the first time and the second time, wherein the likelihood of the fraudulent event is based at least in part on the difference.

18. The non-transitory computer-readable medium of claim 16, wherein the program further causes the at least one computing device to receive second service data from a second computing system, the second service data comprising an automated teller machine request associated with a third time.

19. The non-transitory computer-readable medium of claim 18, wherein determining the likelihood of the fraud event further comprises:
determining a difference between the first time and the third time; and
comparing the automated teller machine request to the credential reset request, wherein the likelihood of the fraudulent event is based at least in part on the determination, the difference, and the comparison between the automated teller machine request and the credential reset request.

20. The non-transitory computer-readable medium of claim 15, wherein the program further causes the at least one computing device to transmit an alert to a second computing system associated with the particular user account.
